(19) United States
(12) Patent Application Publication
(10) Pub. No.: US 2026/0098400 A1
(43) Pub. Date: Apr. 9, 2026

(54) UNDER-SINK SOLIDS SEPARATING AND COMPOSTING DEVICES

(71) Applicant: Kohler Co., Kohler, WI (US)

(72) Inventors: Matthew Tyler Harrison, Kohler, WI (US); Margaret Mazz, Kohler, WI (US); Bil Kuru, Kohler, WI (US); Steven F. Ellingsen, Kohler, WI (US)

(21) Appl. No.: 19/349,528

(22) Filed: Oct. 3, 2025

Related U.S. Application Data
(60) Provisional application No. 63/702,812, filed on Oct. 3, 2024.

(51) Int. Cl. E03C 1/264; B01D 33/01; B01D 33/06; E03C 1/266

(52) U.S. Cl. CPC E03C 1/264; B01D 33/015; B01D 33/06; E03C 1/2665; B01D 2221/02; B01D 2257/80

(57) ABSTRACT

Under-sink solids separating and compositing devices, systems, and methods. An under-sink solids separating device can include a solids separation housing having a fluid opening and a solids opening positioned along a length of the housing between the top and bottom end. The under-sink solids separating device is configured to separate fluid from solids such that fluid exits the housing via the fluid opening and solids exit the housing via the solids opening. A composting device can be coupled to the solids opening of the separating device or a garbage disposal and can include one or more housings or chambers for grinding or processing the solids, one or more heaters or fans for drying the solids, and optionally a mechanism for compacting the processed solids into pucks.

### CROSS REFERENCE TO RELATED APPLICATIONS

This application claims the benefit of U.S. Provisional Application No. 63/702,812 filed on Oct. 3, 2024, the disclosure of which is hereby incorporated by reference in its entirety.

### TECHNICAL FIELD

The present disclosure relates generally to wastewater and foodstuff processing. More particularly, the present disclosure relates to the separation of solid material from sink wastewater and the subsequent processing or composting of the solid material.

### BACKGROUND

Separation systems have been used in various applications to separate solid material from wastewater. Various types of strainers and filters, like screen filters or strainer baskets, allow fluid to pass through the screen while restricting the passage of solid materials. Such separation systems may used to process wastewater that may drain from sinks or other plumbing fixtures so that the wastewater may be released back into the environment or repurposed, while preventing foodstuffs and other solid or semi-solid materials from clogging the plumbing fixtures.

Composting bins may be used in the kitchen to collect organic food waste. Such composting bins may be positioned on a kitchen counter next to a sink, under a cabinet, or even outside. A user can discard food waste into the composting bin, where microscopic organisms such as bacteria, microbes, and fungi can break down the organic material. Over time, the broken-down organic material becomes a nutrient-rich soil (“compost”) that may be used to fertilize plants or a garden, for example. Some composting bins may also utilize an input energy source, such as electricity, to process the discarded material, by heating or grinding it. Such a device may be used to increase the speed at which composting occurs.

While some existing solids separation systems may separate solids from wastewater, they may require frequent maintenance to clean and/or remove the collected solid material to allow it to continue functioning. Additionally, while some composting bins may utilize electricity to efficiently compost organic material, they may still require a user to open the bin, dispose the organic waste, and then close the bin. Additionally, if left on a counter, these bins may take up desirable counterspace in a kitchen. If left in a cabinet, then a user is further inconvenienced by having to open and close the cabinet to access the compost bin. Further, some composting bins may inefficiently transform the organic waste into compost, or in the process of composting, may produce undesirable odors from gasses created in the composting process.

Another common issue in modern kitchens is the loss of otherwise compostable food waste through the plumbing system. Typically, when users rinse dishes or clean up after meals, valuable food scraps are washed down the drain and processed through a garbage disposal. These materials then enter the municipal wastewater system, ultimately reaching the wastewater treatment facility where they are no longer recoverable for composting.

### SUMMARY

Under-sink separating and composting devices and systems may have several advantages over conventional composting bins. A user of the under-sink composting device does not have to open a separate composting bin, discard the organic waste, and then continue washing the dishes. Instead, the user can simply wash all the organic material down the drain. Such a convenient platform to reduce food waste may promote a net positive effect on the environment, while providing users a nutrient-dense compost to use for plants or gardens. Even if the compost is discarded in the trash, methane production that would have occurred in a landfill may be significantly reduced, and less energy is needed to transport composted material to the landfill than non-composted material. Additionally, the under-sink composting device does not occupy valuable counterspace in a kitchen, which may be both aesthetically and usefully desirable. Further, the under-sink composting device may prevent or reduce unpleasant odors dissipating from the compost. Further still, the under-sink composting device may more efficiently (with regards to time and energy) convert organic waste into compost by utilizing a pre-existing heat source. Further still, the under-sink composting device can continuously operate, even while new material is being added to the device. Alternatively, the under-sink separating device may be configured to utilize a pre-existing garbage disposal instead of or in addition to a composting device. Yet further still, a combination under-sink garbage disposal and compositing device may perform both the grinding or cutting operation of a garbage disposal with the separating and composting separation in a single device.

### BRIEF DESCRIPTION OF THE DRAWINGS

The disclosure may be more completely understood in consideration of the following detailed description of examples of the disclosure in connection with the accompanying drawing, in which:

FIG. 1 is a side section view of a solids separation system with an inclined screen filter for use with an under-sink device, according to examples of the present disclosure.

FIG. 2 is a side section view of a solids separation system with a curved surface for use with an under-sink device, according to examples of the present disclosure.

FIGS. 3A and 3B are side section views of solids separation systems with mesh conveyance belts for use with an under-sink device, according to examples of the present disclosure.

FIG. 4 is a side section view of a solids separation system with a mesh conveyance wheel for use with an under-sink device, according to examples of the present disclosure.

FIG. 5 is a side section view of a solids separation system with a mechanical rack for use with an under-sink device, according to examples of the present disclosure.

FIGS. 6A and 6B are side section views of solids separation systems with rollers for use with an under-sink device, according to examples of the present disclosure.

FIGS. 7A-7D are top and side views of solids separation systems with rotating screens for use with an under-sink device, according to examples of the present disclosure.

FIG. 8 is a top view of a solids separation system with a rotating mesh spiralizer for use with an under-sink device, according to examples of the present disclosure.

FIGS. 9A and 9B are side and perspective views of solids separation systems with screw conveyors spiralizer for use with an under-sink device, according to examples of the present disclosure.

FIG. 10 is a side view of a solids separation system with a submerged mesh spiralizer for use with an under-sink device, according to examples of the present disclosure.

FIG. 11 is a side view of a solids separation system with a cyclone separator for use with an under-sink device, according to examples of the present disclosure.

FIGS. 12A-12C are side views of a solids separation system with a drain dumper for use with an under-sink device, according to examples of the present disclosure.

FIGS. 13A-13C are side views of an under-sink composting device, according to examples of the present disclosure.

FIG. 14 is a side view of an under-sink composting device, according to examples of the present disclosure.

FIG. 15A1 and 15B are side views of a multilevel under-sink composting device, according to examples of the present disclosure.

FIG. 16 is a side view of an under-sink composting device, according to examples of the present disclosure.

FIG. 17 is a side view of a convective heat system for use with an under-sink composting device, according to examples of the present disclosure.

FIG. 18 is a side view of a vent system for use with an under-sink composting device, according to examples of the present disclosure.

FIG. 19 is a side view of an example schematic of sink plumbing with a garbage disposal for use with an under-sink composting device, according to examples of the present disclosure.

FIGS. 20A-20C are a method and exemplary devices for implementing the method relating to an under-sink composting device, according to examples of the present disclosure.

FIG. 21 is a process map for an under-sink composting device, according to examples of the present disclosure.

FIG. 22 is a side view of a garbage disposal with a composting separator and grinding mechanism, according to examples of the present disclosure.

While various examples are amenable to various modifications and alternative forms, specifics thereof have been shown by way of example in the drawings and will be described in detail. It should be understood, however, that the intention is not to limit the claimed inventions to the particular examples described. On the contrary, the intention is to cover all modifications, equivalents, and alternatives falling within the spirit and scope of the subject matter as defined by the claims.

### DETAILED DESCRIPTION

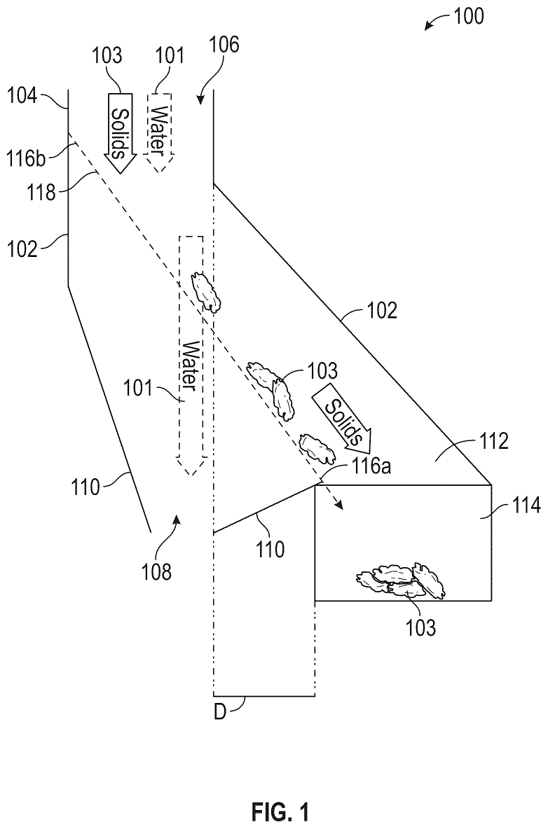

Referring to FIG. 1, a side section view of an under-sink solids separation device 100 using an inclined screen filter solids separation system is shown according to an exemplary implementation. The solids separation device 100 may comprise a solids separation housing 102. A top end 104 of the solids separation housing 102 may define a top opening 106. In some implementations, the top opening 106 may be in fluid communication with a sink drain (not pictured). In other implementations, the top opening 106 may be in fluid communication with a garbage disposal (not pictured). The solids separation housing 102 may be formed from metal, (for example; stainless steel, brass, aluminum, etc.), a polymer (for example, PVC), or a combination thereof. The top end 104 can define threads, a flange, or other geometry configured to couple the top end 104 to a sink drain or garbage disposal.

The solids separation housing 102 further may define a fluid opening 108 in a bottom end 110 of the solids separation housing 102. The fluid opening 108 may be positioned below the top opening 106 such that gravity causes fluids 101 entering the top opening 106 to fall downward through the solids separation housing 102 and out the fluid opening 108. Further, the bottom end 110 can define angled walls to funnel fluid through the fluid opening 108 that may otherwise fall outside the fluid opening 108. Like the top end 104, the bottom end 110 can define threads, a flange, or other geometry configured to couple the bottom end 110 to a drain line, for example (not pictured).

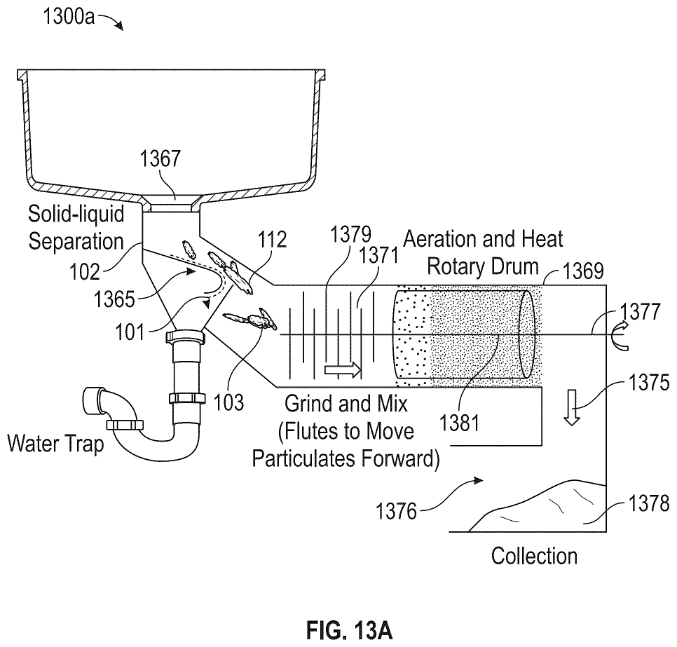

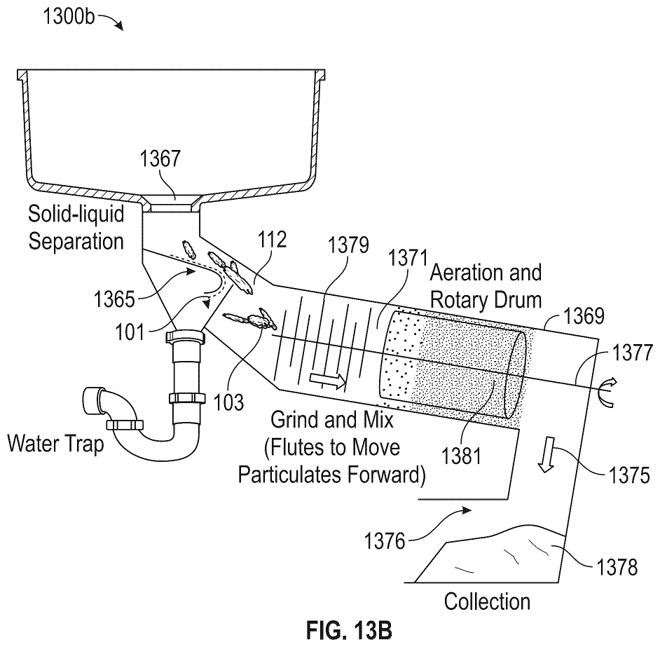

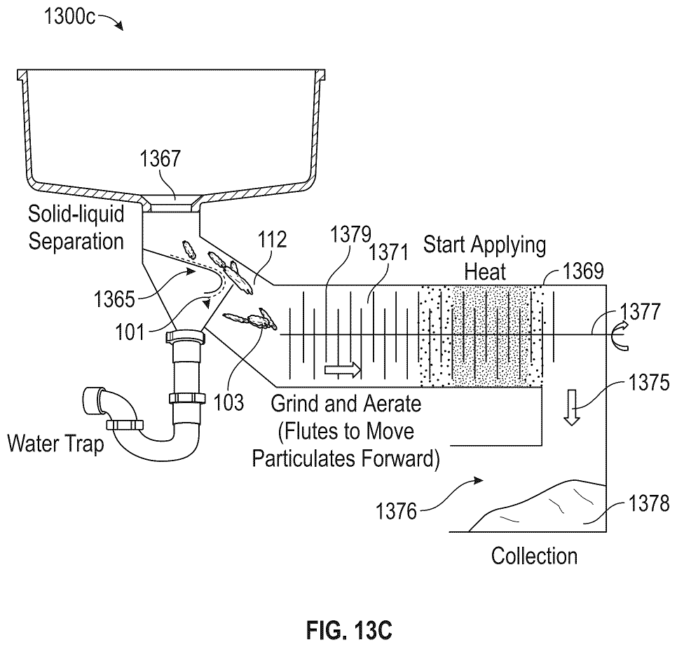

The solids separation housing 102 may further define a solids opening 112. The solids opening 112 may be positioned below and adjacent to the top opening 106 such that there is a distance, D, preventing overlap between the top opening 106 and solids opening 112. Additionally, the solids opening 112 may be disposed above a collection container 114. The solids separation housing 102 portion defining the solids opening 112 can couple to the collection container 114 (for example, via threads, flange, etc.) or be positioned above, or partly within, the collection container 114. In exemplary implementations, the collection container 114 may comprise a composting housing, as discussed in greater detail beginning with FIG. 13, or can alternatively be coupled to or comprise a garbage disposal.

Further, a screen 116 may be disposed within the solids separation housing 102. The screen 116 may be disposed within the solids separation housing 102 such that the fluid opening 108 may be covered by the screen 116, but the solids opening 112 may be minimally covered (or not covered at all) by the screen 116. The screen 116 may be disposed within the solids separation housing 102 such that the screen 116 creates an angle, or incline, with the horizontal. A bottom portion 116a of the screen 116 can extend past the solids opening 112 and attach to, or extend into, the collection container 114. Alternatively, the bottom portion 116a of the screen 116 can connect to the solids separation housing 102 at or near the solids opening 112. A top portion 116b of the screen 116 can connect to the solids separation housing 102 at a top end 104, or at some other location within the solids separation housing 102 located above the bottom portion 116a of the screen 116.

The screen 116 may define holes 118. In some implementations, the holes 118 may be formed in sheet metal or plastic, for example. In other implementations, the holes 118 may be defined by the screen 116 comprising a wire mesh. Accordingly, in some implementations, the screen 118 can define an area that may be mostly occupied by holes 118, mostly occupied by material or any ratio in between. The hole 118 size may be chosen based on the size of the solid desired to be separated. Smaller solids, for example, may require smaller holes 118 to prevent the solid from passing through the holes 118. In some implementations, the screen 116 may be substantially flat such that a plane defined by the holes 118 may be substantially coplanar with a plane defined by the screen 116 (as pictured). In other implementations, the screen 116 can have raised openings, such that planes defined by the holes 118 are not coplanar with a plane defined by the screen 116. Such a non-coplanar design may be desired to break surface tension between the fluid and the screen 116 to allow the fluid to pass through the holes 118.

In use, a user may dispense a mixture of fluid 101 and solids 103 down the drain of a sink. The fluid 101 and solids 103 may pass into the solids separation housing 102 through the top opening 106, which may be in fluid connection with the drain and/or garbage disposal. Gravity then causes the fluid 101 and solids 103 to fall downward to the screen 116. The fluid 101 may falls through the holes 118 of the screen 116 and either directly through the fluid opening 108 or off the angled bottom end 110 then through the fluid opening 108. The fluid 101 may then be disposed of, for example via a connection to a drain line.

The solids 103, however, may be too large to fit through the holes 118 of the screen 116. Thus, the screen 116 may prevent the solids 103 from moving below the screen 116. Instead the angle of the screen 116 can provide a normal force to the solids 103, causing the solids 103 to move down and across the screen 116 towards the solids opening 112. Once the solids 103 pass through the solids opening 112, the solids 102 may be disposed in the collection container 114. As described in more detail in subsequent figures, the solids 103 may then undergo a variety of composting processes, or can alternatively be fed to a garbage disposal. Such a process may allow a continuous solid collection process for composting or processing, without the user needing to manually separate and dispose of the solids.

The solids separation device described with reference to FIG. 1 may share several similarities with subsequently described figures. Accordingly, similar elements will be numbered and named similarly. Further, these similar elements should be considered to share the numerous possible implementations and features that may be described throughout the present disclosure.

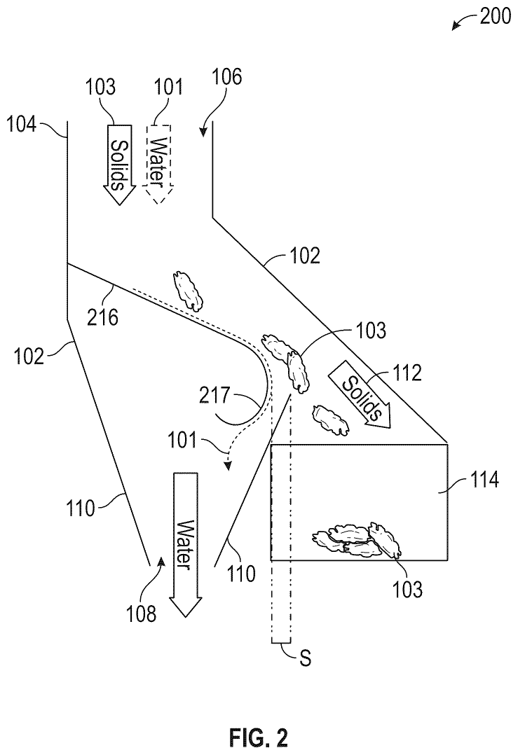

Referring now to FIG. 2, a side section view of an under-sink solids separation device 200 using a curved separation surface 216 may be described according to an exemplary implementation. In this implementation, the under-sink solids separation device may comprise a curved or arcuate separation surface 216. The curved separation surface 216 may be disposed within the solids separation housing 102 such that the fluid opening 108 may be at least partially covered by the curved separation surface 216, but the solids opening 112 is not covered by the curved separation surface 216. A space S may be left open between a curved portion 217 of the curved separation surface 216 and the solids opening 112. The curved separation surface 216 may be connected to the solids separation housing 102 such that the curved portion 217 may be at a lower elevation than where the curved separation surface 216 connects to the housing 102, creating an incline or angle towards a collection container 114 disposed below the solids opening 112. In an exemplary implementation, the curved separation surface 216 may be a solid material, like a stainless steel or plastic, for example. In other implementations, the curved separation surface 216 may define holes like previously described screen 116.

In use, fluid 101 and solids 103 may be dispensed through the top opening 106 and contact the curved separation surface 216. In this example, both the fluid 101 and solids 103 move down the curved separation surface 216 due to the incline of the curved separation surface 216. When the fluid 101 and solids 103 reach the curved portion 217 of the curved separation surface 216, a low-pressure system may be created, causing the fluid 101 to remain on the outer surface of the curved portion 217. This causes the fluid 101 to follow the outer surface of the curved portion 217 back at least some distance under the curved separation surface 216 such that the fluid 101 passes through space S. The pressure differential causing the fluid 101 to at or near the curved portion 217 of the curved separation surface 216 may be created by the Coanda effect. The solids 103, however, have too much inertia and momentum and do not follow the surface of the curved portion 217. Instead, the solids 103 continue a trajectory across space S, through the solids opening 112, and into the collection container 114. Space S, however, may be configured to be small enough to reject solids 103 that nonetheless adhere to the curved portion 217.

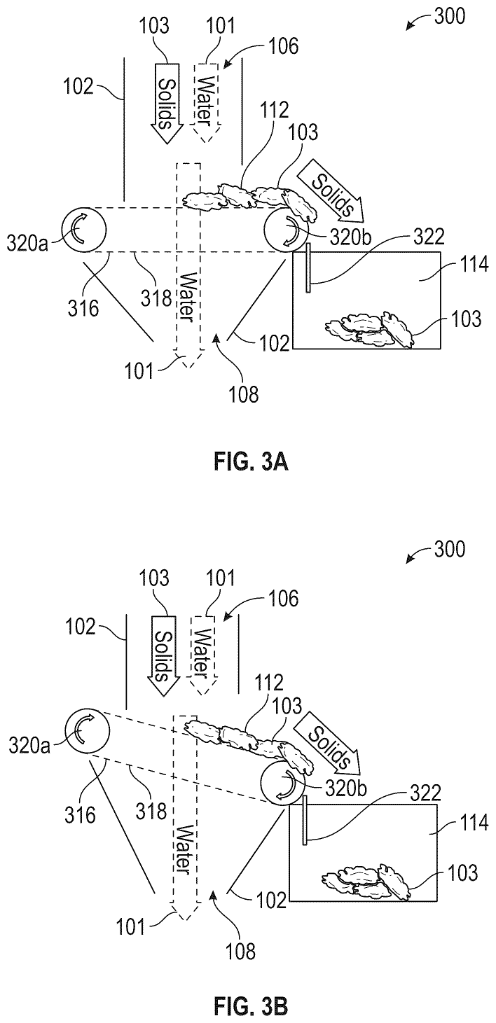

Referring now to FIGS. 3A and 3B, side section views of an under-sink solids separation device 300 using a conveyor separation system are described according to an exemplary implementation. Solids separation device 300 may comprise a conveyance separation screen 316. Conveyance separation screen 316, like previously described screens, may comprise a wire mesh, or sheet metal/plastic that defines holes 318. Conveyance separation screen 316 may be configured to extend across the entire solids separation housing 102 and fluid opening 108. In some implementations the conveyance separation screen 316 may be positioned substantially horizontal (FIG. 3A), while in other implementations it may be inclined (FIG. 3B). Such an incline may be desirable to assist the transfer of solids 103 to the collection container 114 through gravity.

A motor (not pictured) may be connected to a power source (like electrical outlet, or battery, for example) to turn at least one roller 320a, 320b and move the conveyance separation screen 316. A scraper member 322 may be disposed above the collection container 114 and close to the roller 320b to scrape any remaining solids 103 off the conveyance separation screen 316 and into the collection container 114.

In use, fluid 101 and solids 103 enter the solids separation housing 102 through the top opening 108 and reach the conveyance separation screen 316. The fluid passes through the conveyance separation screen 316 and exits the housing through the fluid opening 108. The solids 103 are stopped on the conveyance separation screen 316. As the motor turns the rollers 320a and/or 320b, the conveyance separation screen 316 and solids 103 resting on top move out of the solids separation housing 102 through the solids opening 112. As the conveyance separation screen moves around the roller 320b and back into the solids separation housing 102, the solids 103 are dumped into the collection container 114. Solids 103 that may be stuck to the conveyance separation screen 316 may be scraped from the screen, by the scraper member 322, and into the collection container 103.

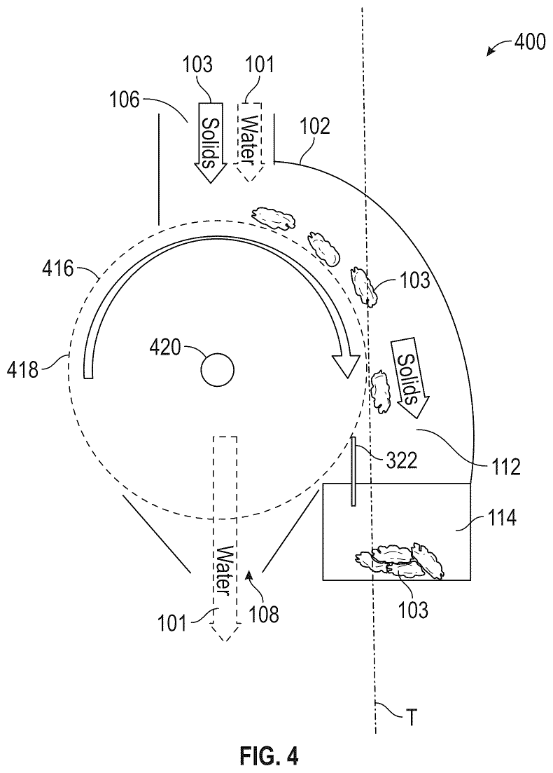

Referring now to FIG. 4, a side section view of an under-sink solids separation device 400 utilizing a mesh conveyance wheel 416 is shown according to another implementation. Solids separation device 400 with mesh conveyance wheel 416 may be substantially similar to the disclosure relating to FIGS. 3A and 3B. However instead of using a substantially planar mesh conveyance screen as shown in FIGS. 3A and 3B, solids separation device 400 of FIG. 4 may utilize a substantially rounded mesh conveyance wheel 416. The mesh conveyance wheel 416 may be supported by a central hub 420. Central hub 420 may be configured to rotate with the activation of a motor that may be electrically connected to a wall outlet or battery, for example. In some implementations, the central hub 420 may comprise a bearing such that when fluid 101 and solids 103 contact the mesh conveyance wheel 416, the resulting force can create a moment around central hub 420, causing the mesh conveyance wheel 416 to rotate around the hub 420. As with previously described screens or meshes, mesh conveyance wheel may be formed from a variety of materials to create different surface finishes and holes 418, to selectively separate various sized solids 103. Additionally, a scraper member 322 may be disposed above the collection container 114 to scrape solids 103 from the mesh conveyance wheel 416 into the collection container 114.

In use, fluids 101 and solids 103 enter the solids separation housing 102 through a top opening 106, which as previously described, may be connected to a sink drain or garbage disposal, for example. Fluids 101 are able to pass through the holes 418 of the mesh conveyance wheel 416 and out the fluid opening 108, which as previously described, may be connected to a drain line. Solids 103 may be stopped from passing through the mesh conveyance wheel 416 because solids 103 do not fit through the holes 418. Instead, the solids 103 rest on top of the mesh conveyance wheel 416. The mesh conveyance wheel 416 then rotates around the central hub 420 such that the solids 103 on top of the mesh conveyance wheel 416 move towards a solids opening 112. Once the solids 103 come close to, or reach, a vertical tangential line T of the mesh conveyance wheel 416, the solids 103 fall off the mesh conveyance wheel 416 due to lack of support under the solids 103 and increased slope. The collection container 114 may be positioned at least partly under the mesh conveyance wheel 416 such that the solids 103 fall into the collection container 114. Solids 103 that may adhere to the mesh conveyance wheel 416 may be scraped from the mesh conveyance wheel 416 and into the collection container 114 by the scraping member 322.

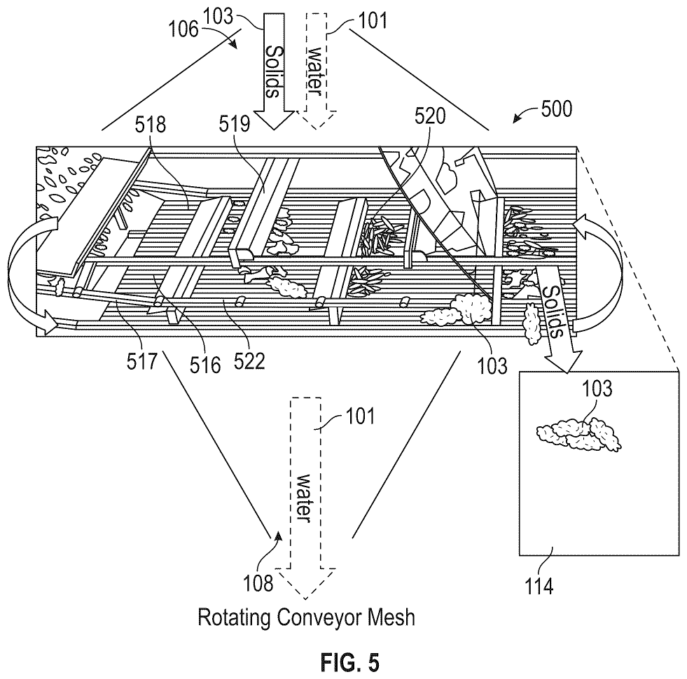

Referring now to FIG. 5, an under-sink solids separation device 500 utilizing a mechanical rack 517 solids separation system is shown, according to an exemplary implementation. Solids separation device 500 may be substantially similar to the solids separation device 300 in FIGS. 3A and 3B but uses a different solids separation system. A screen 516 covers the fluid opening 108 and extends to, or partially overlaps, a solids opening 112. As in previous embodiments, the screen 516 may be comprised of various materials or wire meshes to create holes 518 of different sizes. In some implementations, the screen 516 may comprise a series of parallel bars or rods. Further, a mechanical rack 517 conveyor may be disposed above the screen 516. The mechanical rack 517 may comprise at least one roller (not pictured) configured to rotate the mechanical rack conveyor 517. The mechanical rack 517 may comprise at least one pusher member 519 connected to the mechanical rack 517 and configured to rotate around the mechanical rack 517. When the pusher member 519 is positioned at a top side 520 of the mechanical rack 517, the pusher member travels away from the collection container 114, which may be positioned at least partially below the mechanical rack 517 and screen 516. When the pusher member 519 is positioned at a bottom side 522 of the mechanical rack 517, the pusher member 519 comes close to, or may come into contact with, the screen 516 and travels towards the collection container 114. The pusher member 519 may be a flat-bar shape, concaved to potentially accommodate more solids 103, or any other shape that allows solids 103 to be pushed across the screen 516.

In use, fluids 101 and solids 103 enter the solids separation housing 102 through a top opening 106, which as previously described, may be connected to a sink drain or garbage disposal, for example. Fluids 101 pass through the holes 518 of the screen 516 and out the fluid opening 108, which may be connected to a drain line. Solids 103 may be stopped from passing through the screen 516 because solids 103 do not fit through the holes 518. Instead, the solids 103 rest on top of the screen 516. The pusher member 519 rotates around the mechanical rack 517 conveyance system and moves from the top side 520 to the bottom side 522 and begins traveling towards the collection container 114. The pusher member 519 pushes solids 103 that have been stopped by the screen 516 through the solids opening 112 and into the collection container 114 below.

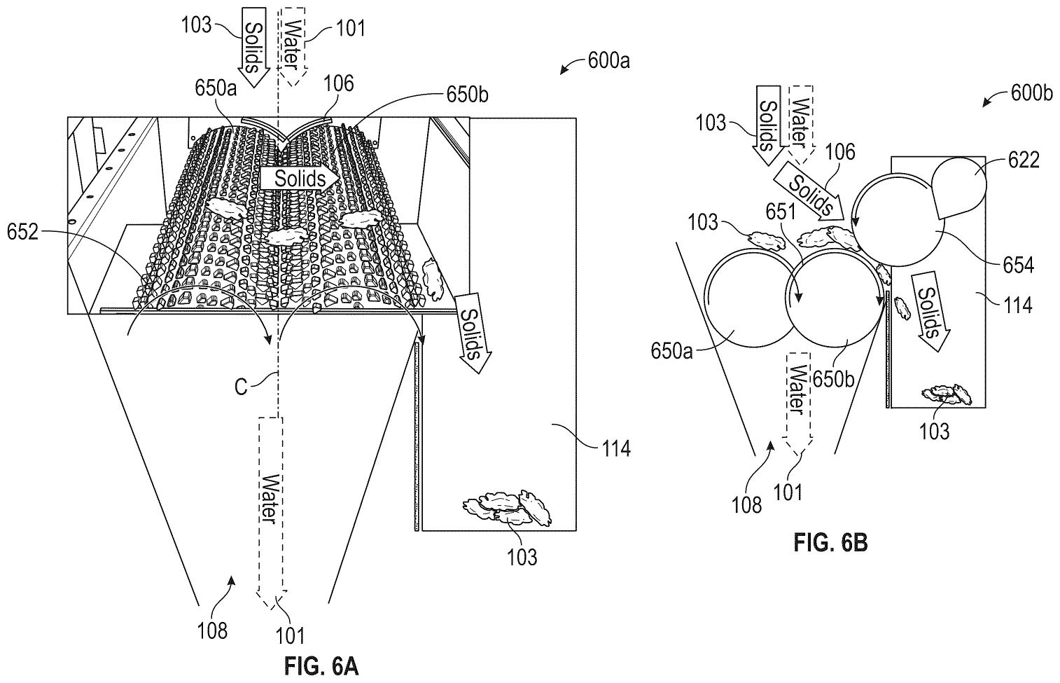

Referring now to FIGS. 6A and 6B, under-sink solids separation device 600a and 600b using separating rollers 650a and 650b are shown, according to exemplary implementations. The separating rollers 650a and 650b are positioned such that a central line C between the separation rollers 650a and 650b may be positioned above the fluid opening 108. In an exemplary implementation, the separation rollers 650a and 650b are substantially parallel to one another. Further, the separation rollers 650a and 650b may be positioned to minimize a gap between them, or, in some implementations, separation rollers 650a and 650b may at least partially overlap via spikes 652 or other interlocking geometries. In some implementations, the solids separation devices 600a and 600b can utilize two separation rollers 650a and 650b (as shown in FIGS. 6A and 6B) but additional separation rollers may be used in other embodiments.

At least one motor (not pictured) may be connected to rotate the separation rollers 650a and 650b. The separation rollers 650a and 650b are configured to rotate in the same direction as one another such that the translational velocity at the top of the separation rollers 650a and 650b may be in the direction of the collection container 114. This may be accomplished, for example, using two motors, or through various gear systems. The collection container 114 may be positioned below and adjacent to one of the separation rollers 650a/650b such that one of the separation rollers 650a/650b may be very close to, or partially overlaps, the collection container 114.

In some implementations (as shown in FIG. 6B), an additional crushing roller 654 may be utilized. The crushing roller 654 may be disposed adjacent to the separation roller 650b that may be closest to the collection container 114. As with separation rollers 650a and 650b, crushing roller 654 may be smooth or spiked, or positioned close to or interlocking with separation roller 650b. In implementations with a crushing roller 654, a scraper member 622 may be positioned above the collection bin 114 such that it may be in contact with, or close to, the crushing roller 654 to scrape off residual solids 103 into the collection bin 114 that might otherwise adhere to the crushing roller. Crushing roller 654 may be configured to rotate in an opposite direction as separation rollers 650a and 650b. This may be accomplished, for example, with the use of another motor, or gear system driven by the motor(s) for the separation rollers 650a and 650b. Crushing roller 654 can further break down solids 103 and can also “squeeze”additional moisture from the solids 103.

In use, fluids 101 and solids 103 may enter the solids separation housing 102 through a top opening 106, which may be connected to a sink drain or garbage disposal, for example. Fluids 101 pass through the central axis C of the separation rollers 650a and 650b due to a narrow gap between the separation rollers 650a and 650b or unsealed interlocking meshing between separation rollers 650a and 650b. Accordingly, fluid 101 moves below the separation rollers 650a and 650b and out the fluid opening 108, which may be connected to a drain line, for example.

Solids 103 may be prevented from moving below the separation rollers 650a and 650b because the solids 103 are too large to fit between a gap or interlocking meshing created by the separation rollers 650a and 650b. Instead, the rotation of the separation rollers 650a and 650b creates a translational movement of the solids 103 across the top of the separation rollers 650a and 650b and towards the collection container 114. Implementations with spikes 652 may create a benefit of additional traction for supporting and gripping solids 103 to move the solids up and across the roller 650b towards the collection container 114. Separation roller 650b may move the solids 103 through the solids opening 112 and into the collection container 114 below.

In implementations with a crushing roller 654 (as shown in FIG. 6B), the solids 103 may undergo an additional crushing phase before being deposited into the collection container below. The crushing roller 654 may rotate to crush the solids 103 between the crushing roller 654 and separation roller 650b such that the solids 103 are further dried and broken. In implementations where the crushing roller 654 comprises spikes 652, the solids 103 may be broken into smaller pieces. Such crushing or breaking down of solids 103 may be desirable for more efficient subsequent composting or processing of the solids 103 after being collected in the collection container 114. In implementations with both a crushing roller 654 and scraper member 622, the scraper member 622 scrapes solids 103 from the crushing roller 654 such that the solids 103 fall into the collection container 114 below.

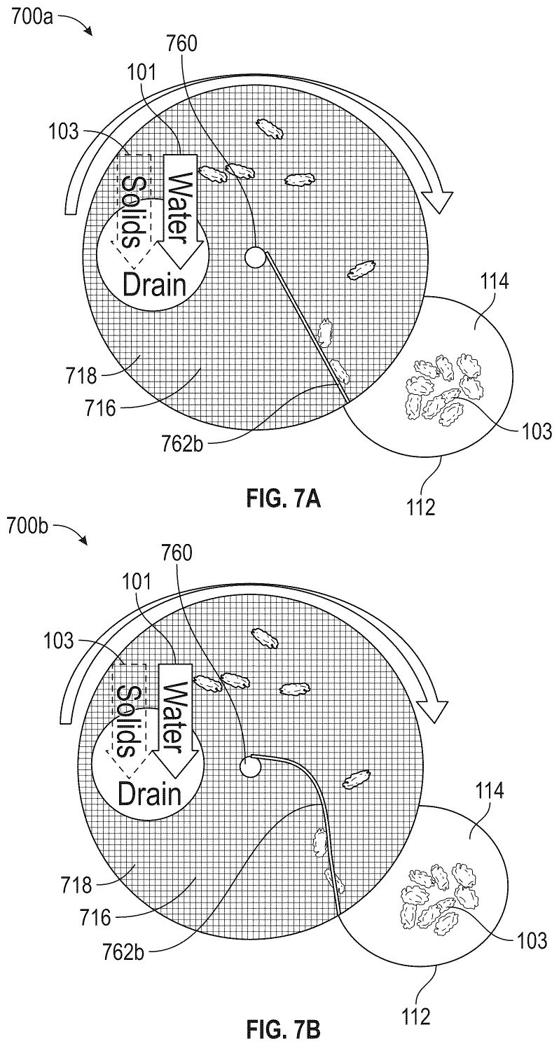

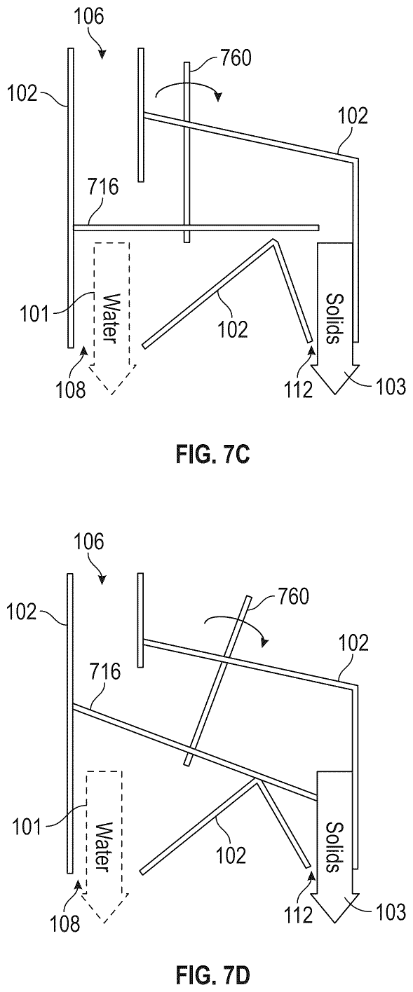

Referring now to FIGS. 7A-D, an under-sink solids separation device 700a/700b with a rotating mesh conveyance screen 716 is shown, according to exemplary implementations. In this implementation, the top opening 106 may be positioned above the fluid opening 108 and a screen 716 may be positioned within the solids separation housing 102 to cover the fluid opening 108. As described in other implementations, the screen 716 may be a wire mesh, or be substantially solid and define holes. Further, the screen 716 may be positioned substantially horizontal (FIG. 7C) or be inclined towards a solids opening 112 (FIG. 7D). The screen 716 may be configured to be very close to, or partially overlap, the solids opening 112 but does not completely cover the solids opening 112. In an exemplary implementation, the screen 716 may be substantially circular.

Further, a shaft 760 may orthogonally protrude from a center of the screen 716. A motor may be configured to rotate the shaft 760, which in turn causes the screen 716 to rotate. In some implementations, as shown in FIGS. 7C and 7D, the shaft 760 may protrude through an opening defined in the solids separation housing 102 and the motor (not pictured) may be configured to rotate the shaft 760 from outside the solids separation housing 102.

A wiper 762a and 762b may be configured to extend from an outer edge of the screen 716 to the shaft 760 such that the wiper 762a and 762b may be substantially parallel with the screen 716 and substantially orthogonal to the shaft 760. The wiper 762a and 762b may be affixed to the solids separation housing 102 such that it remains stationary when the screen 716 rotates. The wiper 762a and 762b may be straight (FIG. 7A), angled or curved (FIG. 7B), or 3-dimensional.

In use, fluids 101 and solids 103 enter the solids separation housing 102 through the top opening 106, which may be connected to a sink drain or garbage disposal, for example. Fluids 101 pass through the holes 718 of the screen 716 and out the fluid opening 108, which may be connected to a drain line. Solids 103 may be stopped from passing through the screen 716 because solids 103 do not fit through the holes 718. Instead, the solids 103 may rest on top of the screen 716. The motor may rotate the shaft 760, which may rotate the screen 716 and solids 103 resting on top of the screen 716. The solids 103 may rotate with the screen 716 until the solids 103 contact the wiper 762a/762b. As the frictional force between the solids 103 and rotating screen 716 push the solids 103 into the wiper 762a/762b, the angle of the wiper 762a/762b causes the solids 103 to move towards the outside of the screen 716 and into the collection container 114 below. In some implementations, the screen 716 may be configured to rotate fast enough such that centrifugal force also acts on the solids 103 to move the solids 103 off the outside of the screen 716. Additionally, in some implementations, the screen 716 may be tilted as in FIG. 7D so gravity applies an additional force to move the solids 103 off the screen 716 and into the collection container below.

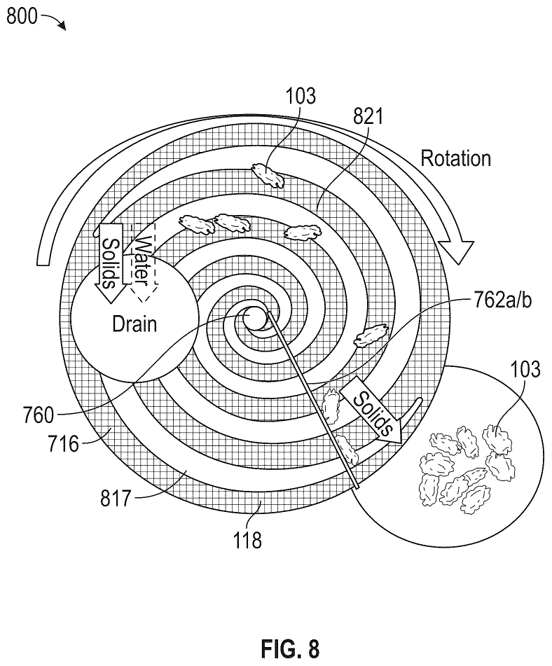

Referring now to FIG. 8, an under-sink solids separation device 800 with a rotating mesh conveyance screen 716 having spiral grooves 817 is shown, according to exemplary implementation. Solids separation device 800 may be substantially similar to solids separation device 700a and 700b shown in FIGS. 7A-D. However, in addition to all the features and variations discussed with reference to solids separation device 700a/700b, solids separation device 800 may further comprise spiral grooves 817. Spiral grooves 817 may extend substantially concentrically outward from the shaft 760 to the outer perimeter of the rotating screen 716. In some implementations, the spiral grooves 817 may protrude upwards and away from the screen 716. In other implementations, spiral grooves 817 may comprise a flat, solid section in the screen 716 such that there are no holes 118 in the spiral grooves 817.

In use, solids separation device 800 operates substantially similar to solids separation device 700a and 700b. However, in addition to the previously described mechanisms and forces that result in the disposal of solids 103 into the collection container 114, the spiral grooves 817 may provide an additional force to move solids 103 from near the shaft 760 to the collection container 114.

In implementations where the spiral grooves 817 are raised from the screen 716, the solids 103 may become positioned in valleys 821 between the spiral grooves 817. As the screen 716 and spiral grooves 817 rotate, the solids 103 are positioned against the wiper 762a/b. As the spiral groove 817 concentrically enlarges with each rotation, the raised spiral groove 817 pushes the solids 103 outwards and into the collection container (along with other forces that may be acting to move the solids 103 in this direction, like gravity, friction, and centrifugal force, for example).

In implementations where the spiral grooves 817 are flat, solid sections, operation may be substantially similar. However, instead of the raised portion of the spiral groove 817 pushing against the solids 103, the flat spiral grooves 817 may provide extra friction that the screen 716 alone might not provide. In this implementation, the added friction (potentially in conjunction with the previous forces and mechanisms described) provides a greater force against the wiper 762a/b, which provides a greater normal force acting against the solids 103 to push the solids 103 towards the collection container 114.

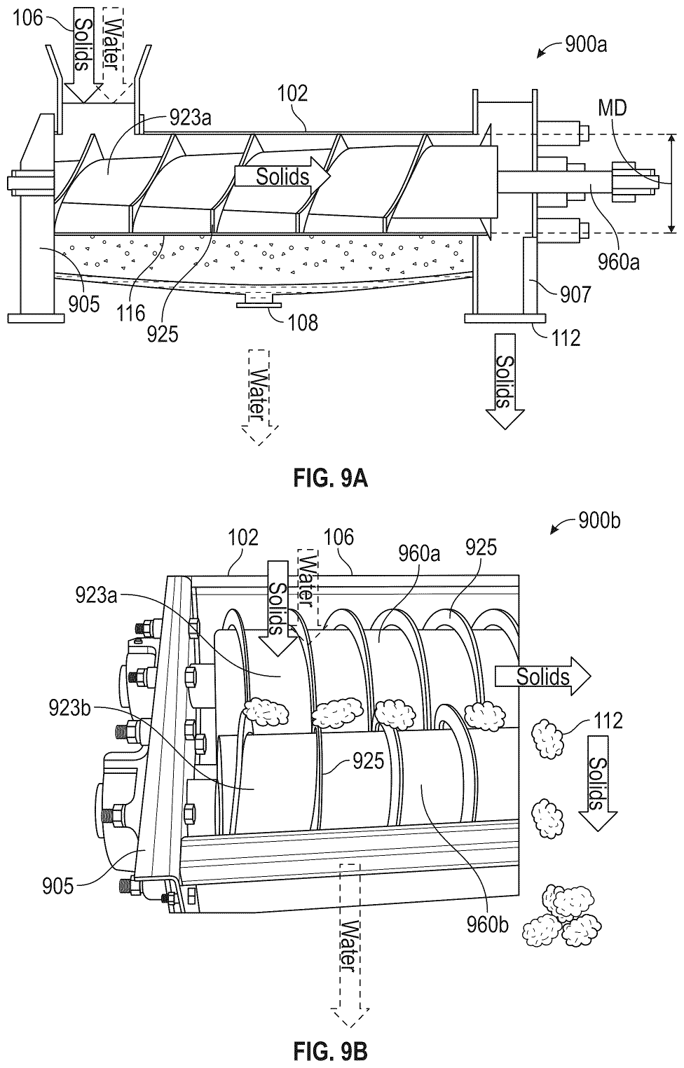

Referring now to FIGS. 9A and 9B, an under-sink solids separation device 900a and 900b are shown using a screw separation system. In this implementation, at least one screw 923a/923b may be disposed within the solids separation housing 102 and above the screen 116. The top opening 106 may be positioned above the at least one screw 923a/923b and may be defined by the solids separation housing 102 near a first end 905. The solids opening 112 may be positioned below the at least one screw 923a/923b and may be defined by the solids separation housing 102 near a second end 907. Further, the screen 116 may be positioned above the fluid opening 108. The at least one screw 923a/923b comprises a helical thread 925, the helical thread 925 having a major diameter MD that extends from or near the screen 116 to or near the top wall of the solids separation housing 102.

In implementations with one screw 923a, a motor may be configured to turn a central shaft 960a of the screw 923a. In such an implementation, the solids separation housing 102 may be substantially cylindrical to house the at least one screw 923a/b. In implementations with two screws 923a and 923b, two motors may be configured to turn two screw shafts 960a and 960b. Alternatively, one motor could be configured to turn both screw shafts 960a and 960b using a variety of gear systems. The helical threads 925 of screws 923a and 923b may be configured to mesh with one another. Further, in some implementations, the at least one screw 923a/923b may be tapered, as shown in FIG. 9A, while in others the screw 923a/b may comprise a consistent diameter. In implementations where the at least one screw 923a/b may be tapered, it may be desirable to have the thicker side near the second end 907 to further condense the solids 103 between the wall of the solids separation housing 102 and the at least one screw 923a/923b, thereby squeezing excess fluid 101 through the screen 116 and further breaking down the solids 103 for subsequent processing. Further, in some implementations, the at least one screw 923a/b may be positioned in the solids separation housing 102 at an incline to aid in separation of water and solids.

In use, fluids 101 and solids 103 enter the solids separation housing 102 through a top opening 106, which may be connected to a sink drain or garbage disposal, for example. Fluids 101 pass below the at least one screw 923a/923b in gaps between the at least one screw 923a/923b and solids separation housing 102 or in spaces between the screws 923a and 923b. The fluid 101 may be also able to pass through the screen 116 (due to the holes created by different variations of screens that have previously been described). The fluid then reaches the bottom of the solids separation housing 102, where the fluid 101 may be funneled towards the fluid opening 108 which as previously described, may be connected to a drain line.

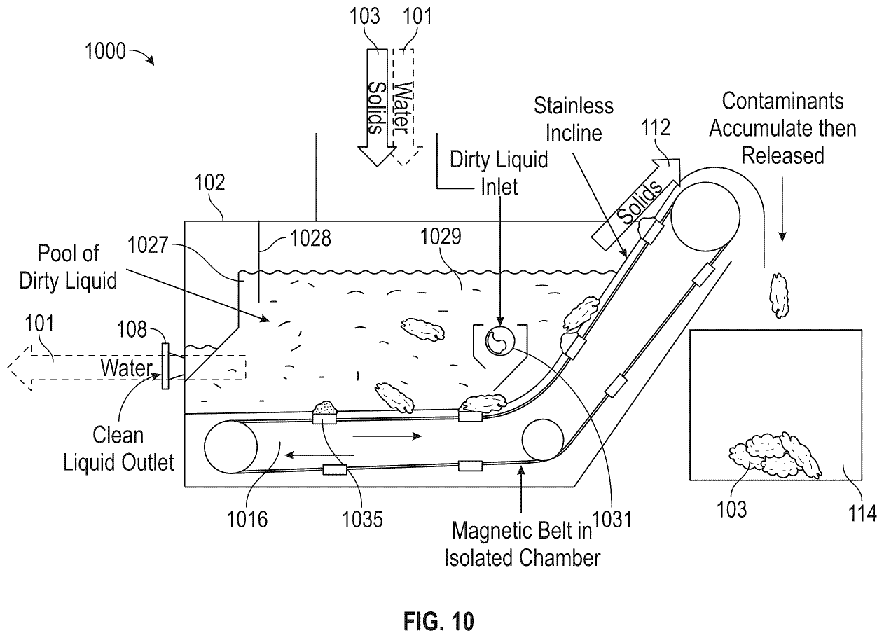

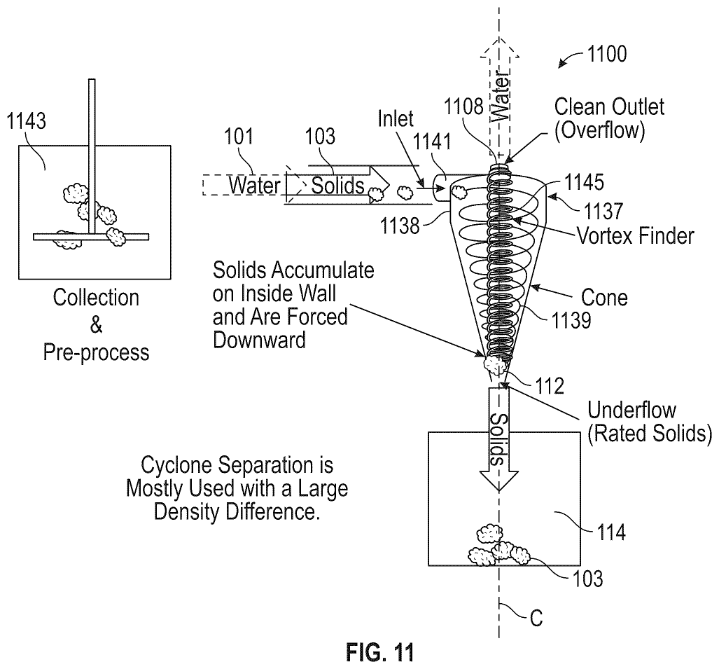

Solids 103 may also move below the at least one screw 923a/923b between open spaces, or if the solids 103 are too large, the solids 103 may rest on top of the at least one screw 923a/b. As the at least one screw 923a/923b, the helical threads 925 push the solids 103 from the first end 905 to the second end 907 and over the solids opening 112 where the solids 103 can fall into a collection container (not pictured). The helical threads 925 and tapered screws 923a/923b may further break down the solids 103. Further, as the solids 103 are pushed across the screen 116, fluid 101 has prolonged opportunities to be removed from the solids 103 and exit the fluid opening 108 below. Referring now to FIG. 10, an under-sink solids separation device 1000 is shown using a submerged mesh conveyance separation system 1016, according to another implementation. As in other previously described implementations, solids separation device 1000 may comprise a solids separation housing 102, a fluid opening 108, and a solids opening 112. The solids separation housing 102 may contain a spillway 1027, which separates the fluid opening 108 from a settling chamber 1029. The solids separation housing 102 may also comprise an obstructing member 1028 adjacent to the spillway 1027 that protrudes into the settling chamber 1029 at least partially below the top of the spillway 1027. The solids separation housing 102 may also define a side opening 1031 configured to dispense the mixture of fluids 101 and solids 103 into the settling chamber 1029.

The conveyance system 1016 may be disposed within the solids separation housing 102 at the bottom of the settling chamber 1029. In an exemplary implementation, the conveyance system 1016 may be configured to be sealed and isolated from the fluids 101 and solids 103 in the settling chamber 1029. The conveyance system 1016 may have a belt 1033 and a plurality of bumps or protrusions 1035. In some implementations, the belt 1033 may comprise a magnetic belt. Further, a collection container 114 may be disposed outside the solids separation housing 102 and at least partially below an inclined portion of the conveyor system 1016. In some implementations, at least the inclined portion of the conveyor system 1016 may be comprised of stainless steel.

In use, fluids 101 and solids 103 enter the solids separation housing 102 and into the settling chamber (from a sink drain, for example) through the side opening 1031. In an exemplary implementation, the side opening 1031 may be positioned near an opposite side of the solids separation housing 102 than the spillway 1027. The fluids 101 and the solids 103 then may separate such that the solids 103 fall to the bottom of the settling chamber 1029 and onto the belt 1033. The belt 1033 and bumps 1035 may move from the separating chamber 1029 through the solids opening 112, and then cycle back into the settling chamber, using a motor and rollers, for example. The bumps 1035 may collect the separated solids 103 and push the solids 103 up through the solids opening 112, where the solids 103 then fall into the collection container 114 below.

The fluids 101 may fill the settling chamber 1029 until the fluids 101 raise the fluid level in the settling chamber 1029 above the spillway 1027. The overflow fluids 101 then move over the spillway 1027 and into the fluid opening, which may be connected to a drain line for example. The spillway 1027 and obstructing member 1028 may be configured to prevent floating solids 103 from exiting the settling chamber 1029 due to the obstructing member 1028 extending into the settling chamber 1029 adjacent to the spillway 1027. Floating solids 103 can only pass over the spillway 1027 by sinking below the obstructing member 1028 and floating back to the surface. Additionally, the obstructing member 1028 may restrict the flow of fluids 101 over the spillway 1028, thereby allowing more settling and separation of solids 103 to occur in the settling chamber 1029.

Referring now to FIG. 11, a side view of an under-sink solids separation device 1100 with a cyclone solid separator 1137 is shown according to another implementation. The cyclone solid separator 1137 may be comprised of a substantially cone-shaped body 1139. A side body opening 1141 may be defined by the body 1139 and may be positioned near a top portion of, and substantially orthogonal to, the body 1139. Further, the side body opening 1141 may be disposed along an inner peripheral 1138 of the of the body 1139 and the side body opening 1141 may be configured to dispense a mixture of fluids 101 and solids 103 into the body 1139 that may come from, for example, a sink drain or garbage disposal. In some implementations, a prefilter 1143 may be fluidly connected between the fluid/solid 101/103 source (drain or garbage disposal, for example) and the body opening 1141 to block some solids 103 from entering the body 1139.

The body 1139 may further comprise a fluid opening 1108. The fluid opening 1108 may be defined in the top of the body 1139 and disposed along a central axis C of the body 1139. The fluid opening 1108 may further comprise a fluid intake pipe 1145 that extends from the fluid opening 1108 into the body 1139. The fluid opening 1108 may be coupled to a drain line, for example.

Further, the body 1139 comprises a solids opening 112 disposed at the bottom (tip) of the cone shaped body 1139. Like the fluid opening 1108, the solids opening 112 may be also disposed along the central axis C. A collection container 114 may be disposed below the solids opening 112.

In use, a mixture of fluids 101 and solids 103 may enter the body 1139 through the body opening 1141. In some implementations, this may occur after passing through the prefilter 1143. The fluid 101 and solid 103 mixture may enter the body 1139 near the top and along the inner peripheral 1138 of the body 1139. The fluid 101 and solids 103 may travel along the inner peripheral 1138 of the body 1139 in a substantially spiraled (cyclone) path, due to the velocity and momentum of the fluids 101 and solids 103. As more fluid 101 and solids 103 enter the body 1139 through the body opening 1141, the body begins to fill with fluids 101 and solids 103, while the trajectory of incoming fluids 101 and solids 103 around the inner peripheral 1138 of the body 1139 creates circulation around the central axis C. The circulation around C can create a cyclone/vortex effect and push the fluids 101 and solids 103 away from the central axis C and towards the inner peripheral 1138 through centrifugal force. Solids 103 with densities greater than fluids 101 experience a greater force and accumulate along the inner peripheral 1138. As the body 1139 continues to fill with fluids 101 and solids 103, the fluid 101 level reaches the fluid opening 1108 (or fluid intake pipe 1145).

Because centrifugal force pushes solids 103 with densities greater than fluids 101 against the inner peripheral 1138, mostly all or all that may be remaining along the central axis C is fluids 101, which are then forced out through the fluid opening 1108 and into a drain line, for example. As the solids 103 accumulate along the inner periphery 1138, the solids 103 are forced downwards through the solids opening 112 and into the collection container 114.

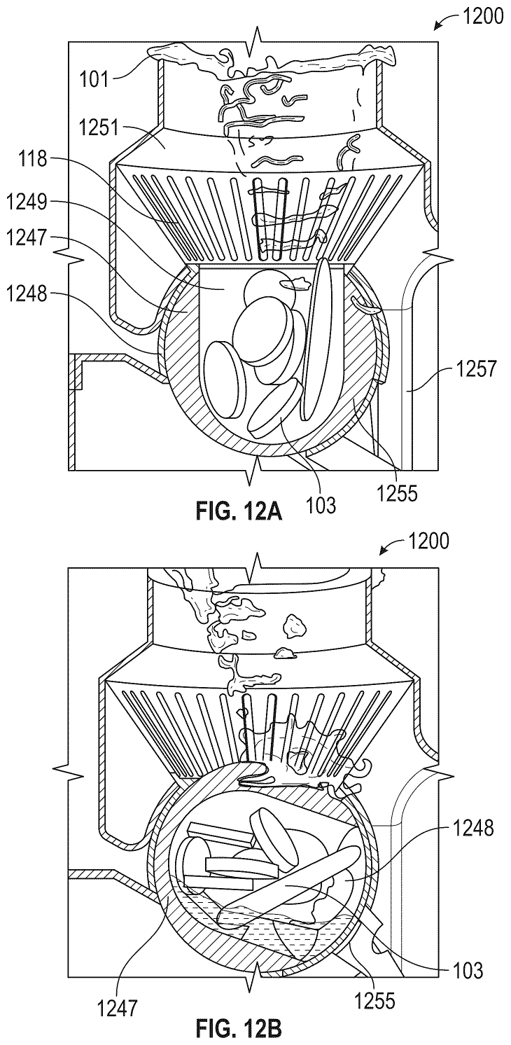

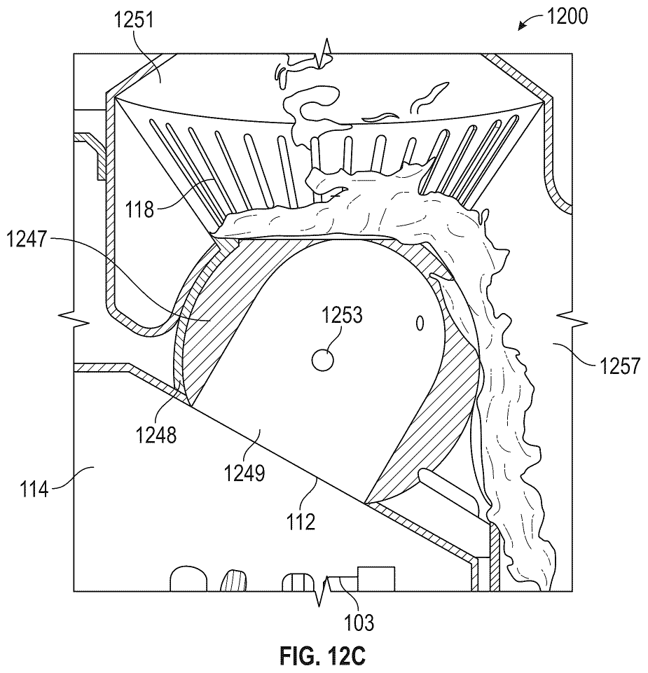

Referring now to FIGS. 12A-12C, a side section view of a drain dumper solids separation system 1200 is shown, according to another implementation. The drain dumper 1200 may comprise a collection cup 1247. The collection cup 1247 may be disposed below a drain and may comprise an open end 1249. Further, the collection cup 1247 may be disposed within a cup shell 1248. The shell 1248 may encompass the collection cup 1247. In an exemplary embodiment, a seal may be formed between the collection cup 1247 and the cup shell 1248. Further, the cup shell 1248 may define a draining section 1255. The draining section 1255 may define openings configured to allow fluid to pass through the draining section 1255, while preventing the passage of solids 103 (similar to subsequently discussed strainer 1251). The draining section 1255 may be positioned between the collection cup 1247 and a drain line 1257.

A strainer 1251 may be disposed within the drain and above the collection cup 1247. Like previously described screens (116), strainer 1251 may define holes 118. The holes 118 may be slot shaped as shown, circular, rectangular, or any other configuration. Further, the strainer 1251 may be formed from a plastic or metal, and define individual holes, slots, or a mesh. The holes 118 are in fluid communication with the drain line 1257.

Further, the collection cup 1247 may be positioned on a pivot point 1253 configured to allow the collection cup 1247 to rotate from a first position (FIG. 12A) through a second position (FIG. 12B) and to a third position (FIG. 12C). Finally, a collection container 114 may be positioned below the collection cup 1247.

In use, the collection cup 1247 may be initially positioned with open end 1249 aligned with the drain (FIG. 12A). As solids 103 and fluids 101 are dispensed down the drain, the solids 103 and fluids 101 enter the interior of the collection cup 1247 through the open end 1249. The collection cup 1247 then may be filled with solids 103 and fluids 101 and may overflow into the strainer 1251. The strainer 1251 allows the fluids 101 to exit the strainer 1251 and into the drain line 1257 through the holes 118, but retains the solids 103.

The collection cup 1247 then rotates around the pivot point 1253 to the second position (FIG. 12B). In the second position, the open end 1249 faces the draining section 1255 of the cup shell 1248. The fluids 101 pass through the draining section 1255 and into the drain line, while the solids 103 are retained by the draining section 1255. In operation, the collection cup 1247 may pause at the second position to allow more fluids 101 to drain through the draining section 1255. In other uses, the collection cup 1247 may be configured to slowly pass through the second position such that most of the fluids 101 exit the collection cup 1247 through the draining section 1255.

The collection cup 1247 then rotates around the pivot point 1253 and into the third position (FIG. 12C). In the third position, the open end 1249 faces downwards towards the collection container 114. Gravitational forces then cause the retained solids 103 to fall through a solids opening 112 and into the collection container 114. The collection cup 1247 may then be returned to the first position (FIG. 12A).

The collection cup 1247 may be configured to rotate between positions, for example, by user activation. For example, a user may push a button, pull a lever, or turn a knob, to provide a force to rotate the collection cup 1247 around the pivot point 1253. In other implementations, for example, a motor may be coupled to the collection cup 1247 or pivot point 1253 to provide a rotational force to control the positioning of the collection cup 1247.

It may be also worth noting that through each of the three positions, the above drain and sink may continuously be used. In all three positions, overflowing solids 103 may be retained in the strainer 1251 while overflowing fluids 101 may be diverted to pass through the holes 118 and into the drain line. In all positions, a sealed connection between the collection cup 1247 and cup shell 1248 may be desirable to prevent fluids 101 from leaking into the below collection container 114. In subsequent disclosures relating to the remaining figures, all of the previously described devices, methods, or systems used to separate solids from liquids will be referred to generically as “a solids separation system 1365”. While certain implementations of solids separation systems is shown in the figures, it may be to be appreciated that the specific systems illustrated are meant to be examples. The subsequent disclosures are intended to include any of the previously described systems, and for the sake of brevity alone, will refer only to a generic “solids separation system 1365”.

Referring now to FIGS. 13A-C, an under-sink solid separation and composting device 1300a-c is shown according to an exemplary implementation. The separation and composting device 1300a-c may comprise a solids separation system 1365 (Disclosure from FIG. 2 shown as example) disposed below a sink drain 1367. A composting housing 1369 may be connected to a solids opening 112 such that the composting housing 1369 receives solids 103 from the solids opening 112. As previously mentioned, composting housing 1369 may be the equivalent of the collection container 114 discussed with reference to FIGS. 1-12. Further, in an exemplary implementation, the composting housing 1369 may be part of, or connected to, the solids separation housing 102. The composting housing 1369 may define a processing tunnel 1371 extending horizontally (FIG. 13A) or, in some implementations, at a slight declination (FIG. 13B) away from the solids opening 112. The composting housing 1369 may further define a vertical (FIG. 13A) or slightly inclined (FIG. 13B) chute 1375. A collection zone 1376 may be disposed at the bottom of the chute 1375 To collect processed material 1378.

The processing tunnel 1371 may contain a centrally disposed rod 1377 extending from or near the chute 1375 to or near the solids opening 112. A motor (not pictured) may be connected to the rod 1377 to provide a rotational force and rotate the rod 1377. The rod 1377 may further comprise a plurality of paddles 1379 positioned adjacent to the solids opening 112. In an exemplary implementation, the rod 1377 may connect to a non-central portion of the paddles 1379 (as shown) to provide an alternating offset pattern. Further, in some implementations, the paddles 1379 may be slightly angled to push solids 103 towards the chute 1375 when the rod 1377 may be rotated. The paddles 1379 may be metal or plastic. In some implementations, the paddles 1379 may be sharpened to further break down solids 103 as the paddles 1379 rotate. Further, in some implementations, the paddles 1379 extend closer to or further from an inner wall of the processing tunnel 1371, thereby increasing or decreasing the crushing of solids 103 between the processing tunnel and paddles 1379. Further still, in some implementations, the paddles 1379 may comprise helical flutes or threads.

In some implementations, as shown in FIGS. 13A and 13B, a rotary drum 1381 may be also disposed around the rod 1377 between the paddles 1379 and the chute 1375. The rotary drum 1381 may be also connected to the rod 1377 such that when the rod 1377 rotates, the paddles 1379 and rotary drum 1381 also rotate. Further, in an exemplary embodiment, the rotary drum 1381 may be configured to provide heat to solids 103 that are in the rotary drum 1381. The rotary drum 1381 may be heated, for example, through an electrical heating element connected to an electrical supply. In other implementations (and as described subsequently in further detail), the rotary drum 1381 may also be configured to convectively receive heat from a hot water line or other nearby heat source. As shown in FIGS. 13A and 13B, rotary drum 1381 may be cylindrical, thus having a circular cross section. In other implementations, the cross section could be triangular, rectangular, pentagonal, hexagonal, or other shape having any number of straight sections and/or curved sections. Such geometries may be desired, for example, for better mixing and aerating performances.

In other implementations, there may be no rotary drum 1381 and the paddles 1379 extend span across at least most of the length of the rod 1377, as shown in FIG. 13C. In this implementation, heat may be applied to at least a portion of the processing tunnel. As previously described, the heat may be supplied through an electrically connected heating element or other heat source, like a hot water line.

In use, a user may discard a mixture of fluids 101 and solids 103 down the drain 1367. The fluids 101 and solids 103 may be separated by the solids separation system 1365. The solids 103 may enter the processing tunnel 1371 of the composting housing 1369 through the solids opening 112. The rod 1377 may rotate, causing the paddles 1379 and rotary drum 1381 to rotate as well (in implementations that have a rotary drum). The rotating paddles 1379 may grind, mix, and aerate the solids 103 by cutting and crushing the solids against the interior walls of the processing tunnel 1371. As the paddles 1379 rotate, the mixed and ground solids 103 may be moved away from the solids opening 112 and towards the chute 1375. The solids 103 may be moved, for example, due to the angles of the rotating paddles 1379. Additionally, like in FIG. 13B, an angled processing tunnel 1371 may create an additional gravitational force to move the solids 103 towards the rotary drum 1381. In implementations such as shown in FIG. 13C, the paddles 1379 may push the solids 103 through a heated section of the processing tunnel 1371 where moisture may be removed from the solids 103, and then down the chute 1375 and to the collection zone 1376.

Implementations shown in FIGS. 13A and 13B, however, move crushed, ground, and aerated solids into the rotary drum 1381. Once the crushed and ground solids 103 are moved inside the rotary drum 1381, the rotating rotary drum 1381 may further mix the crushed solids 103. In the process, the crushed solids may be further aerated, to allow faster decomposition of organic matter. Further, the heat from the rotary drum 1381 may remove some or all of the remaining moisture from the solids 103 and may also quicken the decomposition process for organic materials. As the solids 103 are pushed through the rotary drum 1381, the processed material 1378 may exit the rotary drum 1381, and fall down the chute 1375 to the collection zone 1376. The processed material 1378 represents a collection of dry, organic, particulate matter, or compost.

In general, subsequently described devices, systems, and methods may use substantially similar elements described with reference to FIGS. 13A-13C. For conciseness, when subsequent figures are described using similar element numbers as FIGS. 13A-13C, any variations and implementations discussed regarding those elements from FIGS. 13A-13C are included.

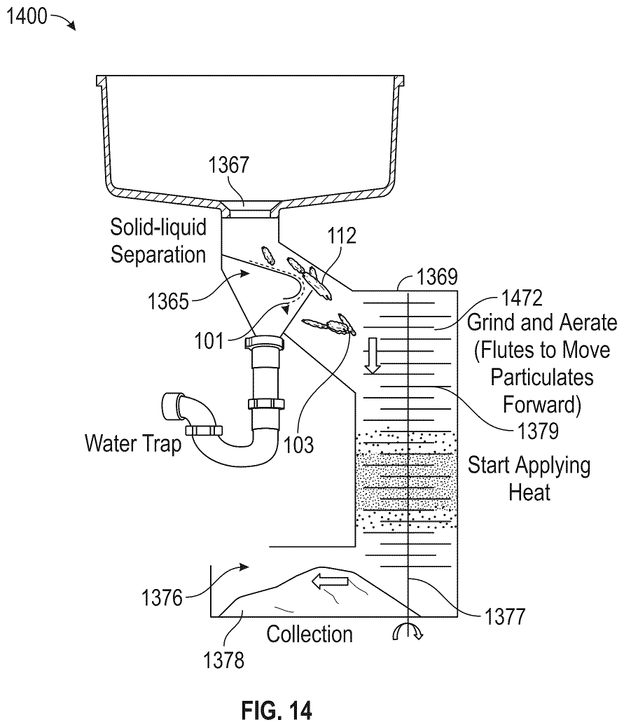

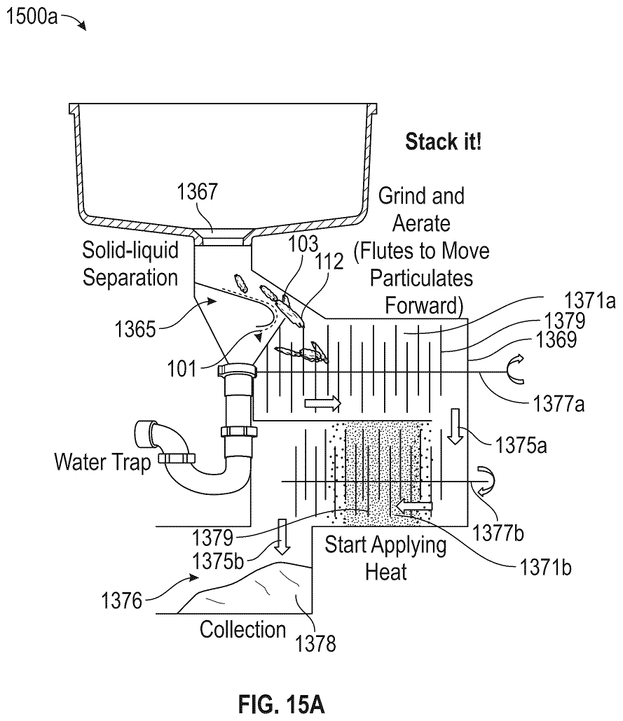

Referring now to FIG. 14, an under-sink solid separation and composting device 1400 is shown according to an exemplary implementation. Composting device 1400 may be similar to composting devices 1300a-c that have been previously described and similar elements are numbered similarly.

Composting device 1400 comprises a solids separation system 1365 (Disclosure from FIG. 2 shown as example) disposed below a sink drain 1367. A composting housing 1369 may be connected to a solids opening 112 such that the composting housing 1369 receives solids 103 from the solids opening 112. The composting housing 1369 may define a processing chute 1472 configured to receive solids 103 from the solids opening 112. The processing chute 1472 may extend substantially vertically from the solids opening 112 downwards to a collection zone 1376. The collection zone 1376 may be disposed at the bottom of the processing chute 1472 and may be configured to collect processed material 1378.

Theonduitsing chute 1472 may contain a centrally disposed rod 1377 extending from or near the solids opening 112 to or near the collection zone 1376. A motor (not pictured) may be connected to the rod 1377 to provide a rotational force and rotate the rod 1377. The rod 1377 may further comprise a plurality of paddles 1379 positioned along a substantial length of the rod 1377. In an exemplary implementation, the rod 1377 may connect to a non-central portion of the paddles 1379 (as shown) to provide an alternating offset pattern. Further, in some implementations, the paddles 1379 may be slightly angled to push solids 103 towards the collection zone when the rod 1377 may be rotated. The paddles 1379 may be metal or plastic. In some implementations, the paddles 1379 may be sharpened to further break down solids 103 as the paddles 1379 rotate. Further, in some implementations, the paddles 1379 may extend closer to or further from an inner wall of the processing chute 1472, thereby increasing or decreasing the crushing of solids 103 between the processing chute 1472 and paddles 1379. Further still, in some implementations, the paddles 1379 may comprise helical flutes or threads.

Heat may be also applied to at least a portion of the processing chute 1472. As previously described, the heat may be supplied through an electrically connected heating element or other heat source, like a hot water line. Also, like previously described, the heat can further dry the solids 103 and quicken the composting process.

In use, a user may discard a mixture of fluids 101 and solids 103 down the drain 1367. The fluids 101 and solids 103 are separated by the solids separation system 1365. The solids 103 enter the processing chute 1472 of the composting housing 1369 through the solids opening 112. The rod 1369 rotates, causing the paddles 1379 to rotate as well. The rotating paddles 1379 grind, mix, and aerate the solids 103 by cutting and crushing the solids against the interior walls of the processing chute 1472. As the paddles 1379 rotate, the mixed and ground solids 103 are moved down the processing chute 1472 due to gravity, as well as forces from the paddles 1379. The solids 103 may be moved, for example, due to the angles of the rotating paddles 1379. Once the solids 103 have passed through the processing chute 1472, it reaches the collection zone 1376 as compost, or processed material 1378.

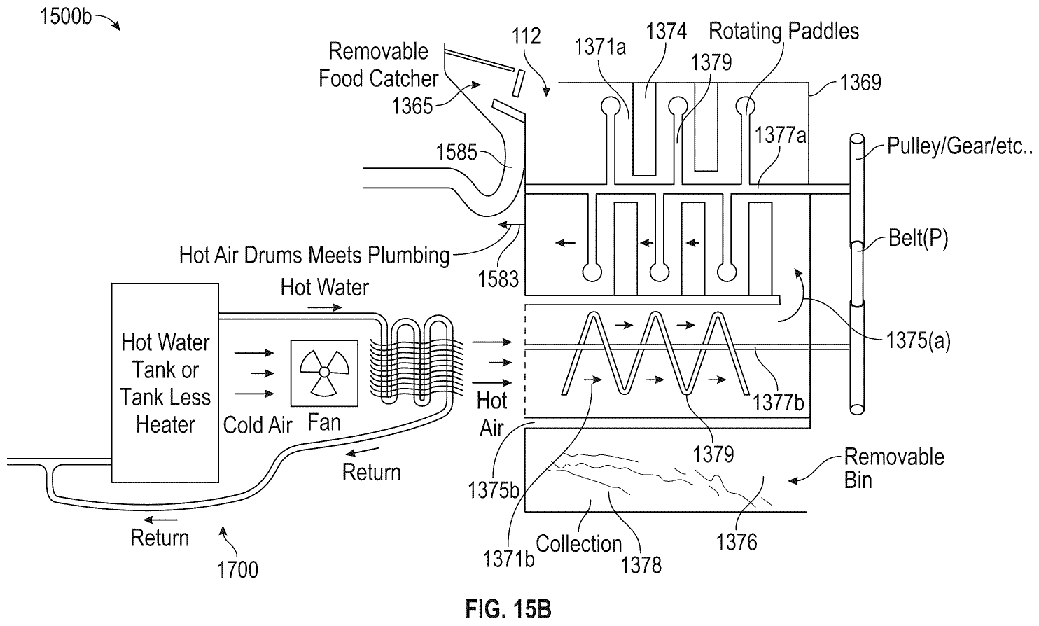

Referring now to FIGS. 15A and 15B, a multilevel under-sink solid composting device 1500a/1500b is shown according to exemplary implementations. The separation and composting devices 1500a/1500b may comprise a solids separation system 1365 (disclosure from FIG. 2 shown as example) disposed below a sink drain 1367. A composting housing 1369 may be connected to a solids opening 112 such that the composting housing 1369 receives solids 103 from the solids opening 112. The composting housing 1369 may define a first processing tunnel 1371a extending horizontally or, in some implementations, at a slight declination away from the solids opening 112 and towards a vertical or near-vertical first chute 1375a defined by the composting housing 1369. A second processing tunnel 1371b may be defined by the composting housing 1369 below, and connected to, the first chute 1375a. The second processing tunnel 1371b extends from the first chute 1375a to a vertical or near vertical second chute 1375b. Like the first processing tunnel 1371a, second processing tunnel 1371b may extend horizontally, or at a declination. Further, in an exemplary implementation, the second processing tunnel 1371b may be positioned below the first processing tunnel 1371a such that the first processing tunnel 1371a may be “stacked” on top of the second processing tunnel 1371b. Such an arrangement may be desired to make the system more space efficient, for example. In some implementations, as shown in FIG. 15B a vent 1583 may be disposed in the composting housing 1369 and be in fluid connection with a drain line 1585. A vent 1583 may be useful to prevent a buildup of gasses within the composting housing 1369 as organic materials decompose. A vent 1583 may also be useful to prevent humid air from collecting under the sink, which may cause mold, amongst other problems. Such a vent 1369 may be utilized by any of the previously or subsequently described implementations. Further, a collection zone 1376 may be disposed below the second chute 1375b. In some implementations, the collection zone 1376 may comprise a removable bin.

The first and second processing tunnels 1371a/1371b may contain a centrally disposed first and second rod 1377a/1377b, respectively. The first rod 1377a may extend from or near the first chute 1375a to or near the solids opening 112. The second rod 1377b may extend from or near the first chute 1375a to or near the second chute 1375b. At least one motor (not shown) may be connected to the first and second rods 1377a/1377b to provide a rotational force to rotate the first and second rods 1377a/1377b. In some implementations the first and separate rods 1377a/1377b may be connected to separate motors. In other implementations, a gear and/or belt system may be utilized to provide a rotational force to both the first and second rods 1377a/1377b with only one motor.

The first and second rods 1377a/1377b further comprise a plurality of paddles 1379 positioned along a substantial length of the first and second rods 1377a/1377b. In an exemplary implementation, the first and second rods 1377a/1377b may connect to a non-central portion of the paddles 1379 (as shown in FIG. 15A) to provide an alternating offset pattern. In other implementations, paddles 1379 may be centrally connected to the rods 1377a/1377b (as shown in FIG. 15B). Further, in some implementations, the paddles 1379 may be slightly angled to push solids 103 towards the first and second chutes 1375a/1375b when the first and second rods 1377a/1377b are rotated. The paddles 1379 may be metal or plastic. In some implementations, the paddles 1379 may be sharpened to further break down solids 103 as the paddles 1379 rotate. Further, in some implementations, the paddles 1379 may extend closer to or further from an inner wall of the first and second processing tunnels 1371a/1371b, thereby increasing or decreasing the crushing of solids 103 between the processing tunnel and paddles 1379. Further still, in some implementations, the paddles 1379 may comprise helical flutes or threads, as shown in the second processing tunnel 1371b in FIG. 15B. The first and/or second processing tunnels 1371a/1371b may also define a plurality of barriers 1374 (as shown in FIG. 15B). The solids 103 are moved over and below the barriers 1374 as the solids 103 move through the first and second processing tunnels 1371a/1371b, thus further aerating and breaking down the solids 103.

In some implementations, a rotary drum (not pictured, but as discussed with reference to FIGS. 13A and 13B) may be used in the first and/or second processing tunnels 1371a/1371b. For example, the rotary drum could replace the paddles 1379 in the second processing tunnel 1371b, or be added to operate with the processing paddles 1379. In implementations with the rotary drum, the rotary drum may be configured to provide heat to solids 103 that are in the rotary drum. The rotary drum may be heated, for example, through an electrical heating element connected to an electrical supply. In other implementations (and as described subsequently in further detail), the rotary drum may also be configured to receive heat from a convective heat system 1700. Further, rotary drum may have a cross section that may be triangular, rectangular, pentagonal, hexagonal, or other shape having any number of straight sections and/or curved sections. Such geometries may be desired, for example, for better mixing and aerating performances.

In other implementations, there may be no rotary drum and heat may be applied to the first and or second processing tunnels 1371a/1371b. In an exemplary implementation, heat may be applied to the second processing tunnel 1371b to further dry and decompose the solids 103. In other implementations, the first and second processing tunnels 1371a/1371b may be heated, either completely or partially across the length of the first and second processing tunnels 1371a/1371b. The first and/or second processing tunnels 1371a/1371b may be heated, for example, through an electrical heating element connected to an electrical supply. In other implementations (and as described subsequently in further detail), the first and second processing tunnels 1371a/1371b may be configured to configured to receive heat from a convective heat system 1700.

In use, a user may discard a mixture of fluids 101 and solids 103 down the drain 1367. The fluids 101 and solids 103 may be separated by the solids separation system 1365. The solids 103 may enter the first processing tunnel 1371a of the composting housing 1369 through the solids opening 112. The first rod 1377a may rotate, causing the paddles 1379 (and in some implementations, the rotary drum) to rotate. The rotating paddles 1379 may grind, mix, and aerate the solids 103 by cutting and crushing the solids against the interior walls of the first processing tunnel 1371a. As the paddles 1379 rotate, the mixed and ground solids 103 are moved away from the solids opening 112 and towards the first chute 1375a. The solids 103 may be moved, for example, due to the angles of the rotating paddles 1379. Additionally, an angled first processing tunnel 1371a may create an additional gravitational force to move the solids 103 towards first chute 1375a. The first processing tunnel 1371a may also be configured to provide heat to the solids 103 to remove moisture and increase the rate of decomposition. The solids 103 eventually are forced to the first chute 1375a.

The solids 103 then may fall down the first chute 1375a and into the second processing tunnel 1371b. The second processing tunnel 1371b may be identical to the first processing tunnel 1371a, or may be different. The second rod 1377b may rotate, causing the paddles 1379 (and in some implementations, the rotary drum) to rotate. The rotating paddles 1379 may grind, mix, and aerate the solids 103 by cutting and crushing the solids against the interior walls of the second processing tunnel 1371b. As the paddles 1379 rotate, the mixed and ground solids 103 are moved away from the first chute 1375a and towards the second chute 1375b. The solids 103 may be moved, for example, due to the angles of the rotating paddles 1379. Additionally, an angled second processing tunnel 1371b may create an additional gravitational force to move the solids 103 towards second chute 1375b. The second processing tunnel 1371b may also be configured to provide heat to the solids 103 to remove moisture and increase the rate of decomposition. The solids 103 eventually are forced to the second chute 1375b where the solids 103 fall into the collection zone 1376 as compost, or processed material 1378. In some implementations, the collection zone 1376 may be removed to empty the compost or processed material 1378.

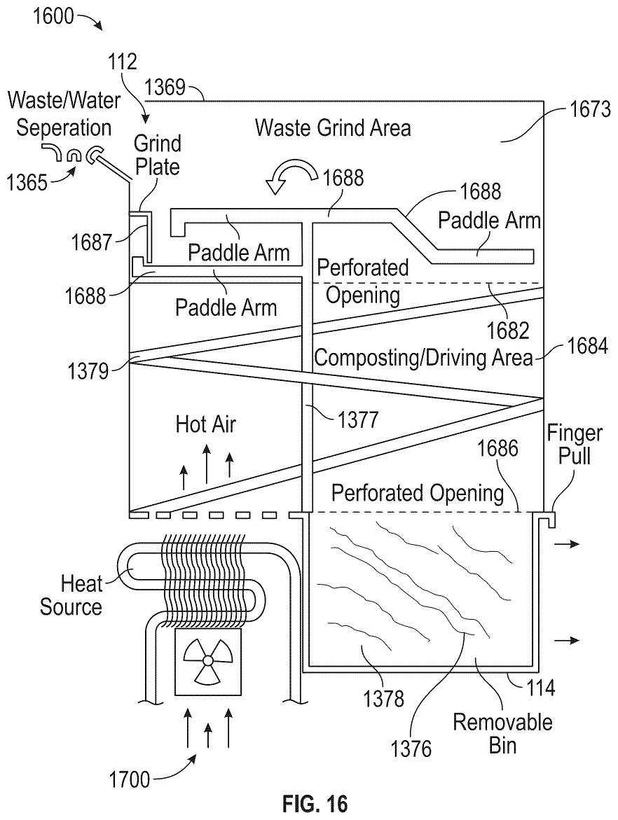

Referring now to FIG. 16, an under-sink solid separation and composting device 1600 is shown according to an exemplary implementation. The separation and composting device 1600 may comprise a solids separation system 1365 (Disclosure from FIGS. 6A and 6B shown as example) disposed below a sink drain (not pictured) or garbage disposal (not pictured). A composting housing 1369 may be connected to a solids opening 112 such that the composting housing 1369 receives solids 103 from the solids opening 112. The composting housing 1369 may comprise an at least partially perforated divider 1682 disposed in the composting housing 1369 to divide the composting housing 1369 into a top grind area or chamber 1673 and a bottom processing area or chamber 1684. A grind plate 1687 may be attached to an inner wall of the composting housing 1369 to extend into the grind area 1673. Further, a perforated floor 1686 may be disposed at the bottom of the processing area 1684. A collection zone 1376 may be disposed below the perforated floor 1686. In some implementations, the collection zone 1376 comprises a removable bin with a protrusion for a user to pull the collection zone 1376 away from the composting housing 1369.

A central shaft or rod 1377 may be vertically and centrally disposed within the composting housing 1369 such that the rod 1377 extends from the perforated floor 1686, through the processing area 1684, through the perforated divider 1682, and at least partially into the grind area 1673. In the grind area 1673, a plurality of grinding arms 1688 may be connected to the rod 1377 and extend radially outward. The grinding arms 1688 may comprise a variety of different shapes, as shown. In an exemplary implementation, at least one of the grinding arms 1688 may be configured to pass through the grind plate 1687, and at least one of the grinding arms 1688 may be disposes to have a narrow clearance with the divider 1682. In the processing area 1684, a plurality of paddles 1379 extend radially outward from the rod 1377. In some implementations, the paddles 1379 may comprise a helical flute, or thread. In other implementations, the paddles 1379 may comprise a plurality of arms configured to further crush, grind, and/or cut solids. Further, a motor (not pictured) may be configured to turn the rod 1377.

Further, the composting housing 1369 may be configured to receive heat to further dry and decompose organic solids. The heat may be supplied for example, from a convective heating system 1700 that moves heated air through a perforated section of the perforated floor 1686. In other implementations, an electrical heating element may be configured to heat the composting housing 1369.

In use, a user may discard a mixture of fluids and solids down the drain. The fluids and solids may be separated by the solids separation system 1365, or may be manually separated. The solids may enter the top grind area 1673 of the composting housing 1369 through the solids opening 112.

The first rod 1377 may rotate, causing grinding arms 1688 to rotate. The grinding arms 1688 may grind, mix, and aerate the solids by cutting and crushing the solids against the interior walls of the composting housing 1369. Solids may be further deteriorated as the grinding arms crush and grind solids against the grind plate 1687 and perforated divider 1682. In some implementations, the solids may also be receiving heat to further decompose and dry the solids. The grinding arms 1688 may continue to break down the solids until the solids are small enough to exit the top grind area 1673 through the perforations in the perforated divider 1682.

Once the solids are pushed through the perforated divider 1682, the solids may move into the processing area 1684. As the rod 1377 rotates, the paddles 1379 in the processing area 1684 may rotate, causing the solids to be further broken down and moved lower in the processing area. In implementations using a convective heating system 1700, heated air may be forced through the processing area 1684 to further dry the solids. As previously mentioned, heat may also be provided conductively, through an electrical heating element. Once the solids reach the bottom of the processing area 1684, the solids may have become processed material 1378, or compost. The processed material 1378 then may be moved through the perforations in the perforated floor 1686 either by gravity or force from the paddles 1379 or above solids.

After the processed material 1378 moves through the perforations in the perforated floor 1686, the processed material 1378 may land in a collection zone 1376. In an exemplary implementation, the collection zone 1376 may comprise a removable chamber or bin with a protrusion, or “finger pull” so a user can remove the collection zone 1376 from the composting housing 1369 to empty the collection zone 1376.

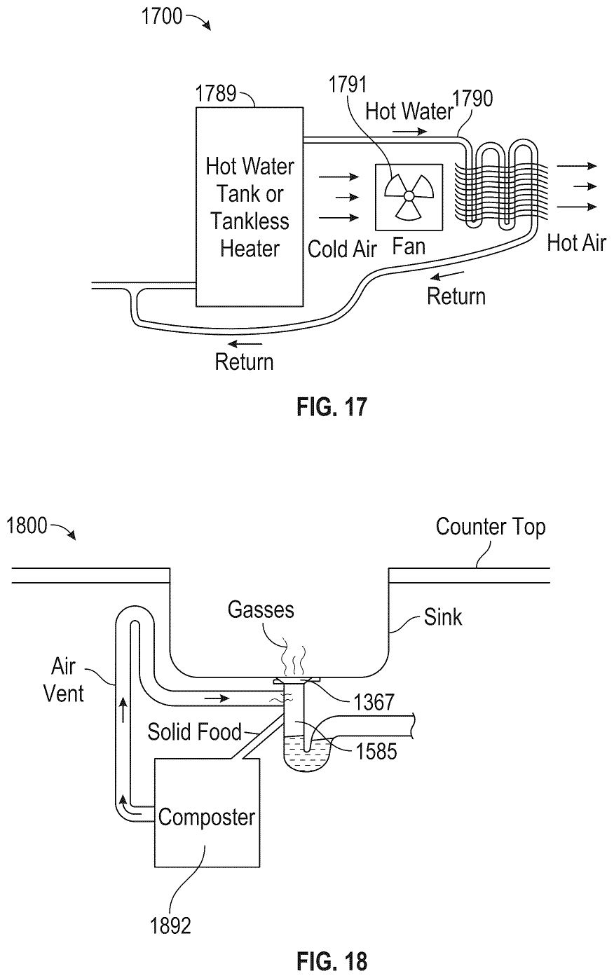

Referring now to FIG. 17, a convective heating system 1700 is shown according to an exemplary implementation. The convective heating system 1700 may comprise a heat source 1789. In an exemplary implementation, the heat source comprises a hot water tank or tankless water heater. In other implementations, the heat source may comprise, for example, hot wastewater from a dishwasher. The convective heating system 1700 may further comprise a heat conduit 1790.

The heat conduit 1790 may be fluidly connected to the heat source 1789 and may define a fluid path for heated fluids to travel closer to the under-sink composting device. In implementations where the heat source 1789 comprises a water heater (tank or tankless), the heat conduit 1790 may further define a fluid path back to the water heater for reheating and recirculation. Such a fluid path may be created, for example, by modifying the hot water line to the sink. In Implementations where the heat source 1789 comprises a dishwasher, the heat conduit 1790 may further comprise a fluid path to a garbage disposal or waste water drain line. In some implementations, the heat conduit 1790 may form a plurality of loops or turns near the under-sink composting device to increase surface area for convective heat transfer. Further, in some implementations, the heat conduit 1790 may be formed from PVC pipe. In other implementations, theonduitt 1790 may be formed from metal materials, for example, like copper. A metal heat conduit 1790 may be advantageous, for example, to transfer heat more efficiently through the heat conduit 1790.

The convective heating system 1700 may further comprise a fan 1791 configured to force air to move past the heat conduit 1790 and towards, or into, the composting housing. The heat conduit 1790 may transfer heat to the air to raise the temperature of the air before it reaches the under-sink composting device. Heating the under-sink composting device may be advantageous, for example, to more efficiently dry and decompose organic material, which may lead to quicker composting capabilities and decreased odors.

It is to be appreciated that the convective heat system 1700 may be implemented with any of the previously described under-sink composting devices. As shown in FIGS. 15B and 16, for example, the composting housing may have perforations to allow the heated air to enter inside the composting housing. Although not explicitly shown, any of the composting devices in the other figures may similarly implement perforations to allow the heated air to interiorly circulate. Alternatively, or in addition to the internal circulation, the heated air may be directed to the outside of the composter housing, thereby heating the device as whole. In yet other implementations, any combination of heating methods previously described may be implemented, such as, for example, additional electrical heating elements disposed within or outside the composting housing, or a heated rotary drum.

Referring now to FIG. 18, an under-sink composting vent system 1800 is shown, according to an exemplary implementation. Vent system 1800 may comprise a solid separation and composting device 1892 configured to receive solids discarded down a drain 1367. Composting device 1892 may comprise any of the composting devices previously described (for example, composting devices 1300-1600) and may be configured to receive solids through any of the solids separation systems previously described (for example, separation systems 100-1200). Vent system 1800 may further comprise a vent 1583 configured to fluidly connect the composter 1892 to the drain 1367 or a drain line 1585. The vent 1583 may comprise a portion that may be elevated from where the vent 1583 connects to the drain 1367 or drain line 1585 (as shown). Such a vent 1583 may be advantageous, for example, to allow gasses and moisture to escape the composter 1892 as organic materials decompose and dry. A vent 1583 may be particularly advantageous in implementations using a convective heat source to circulate heated air throughout the interior of the composter 1892. The vent 1583 may lessen restrictions on warm air flow throughout the composter 1892 by creating a larger opening to atmospheric pressure, thus allowing a greater volumetric flow rate of warmed air to move through the composter 1892. Further still, such a vent system 1800 may be advantageous to allow humid air to escape from under the sink. Reducing the collection of humid air under the sink may prevent mold and provide other sanitary benefits, for example.

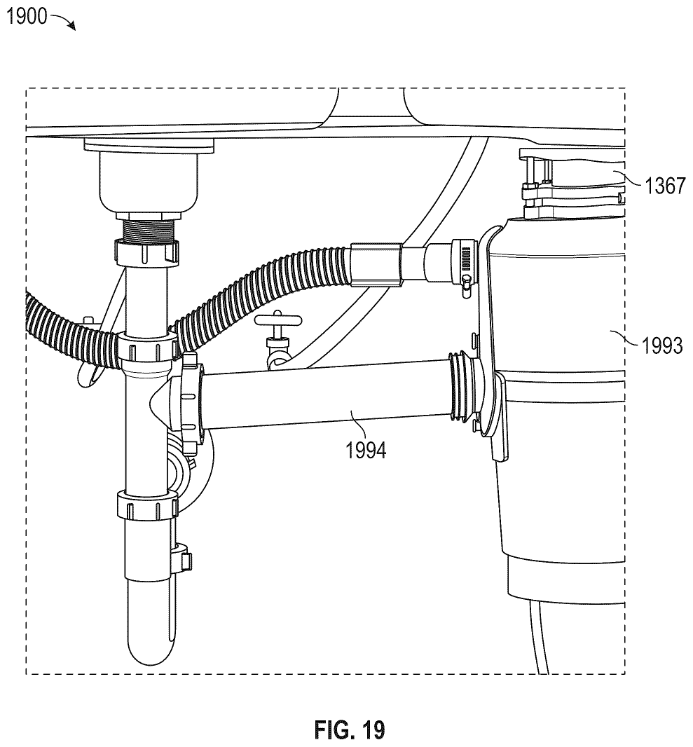

Referring now to FIG. 19, an example schematic 1900 is shown to illustrate how any of the previously described solid separation and composting devices (not pictured) may be configured to operate with a garbage disposal 1993. The garbage disposal 1993 may be fluidly connected to the sink drain 1367. Further, a discharge tube 1994 may be fluidly connected to the garbage disposal 1993 to provide an outlet for discharged material. The separation and composting device may be fluidly connected to the discharge tube such that the discharged material enters the solid separation and composting device. Once the discharged material has entered the solid separation and composting device, the solids may be separated from the fluids according to any separation system previously described or manually, and the solids are further processed according to any of the composting and processing systems previously described. An exemplary advantage of this use may be the reduced need for processing within the composting device because the garbage disposal 1993 may already adequately break down the solids into small pieces. It is also to be appreciated that any of the heating and venting methods may be implemented in this use as well.

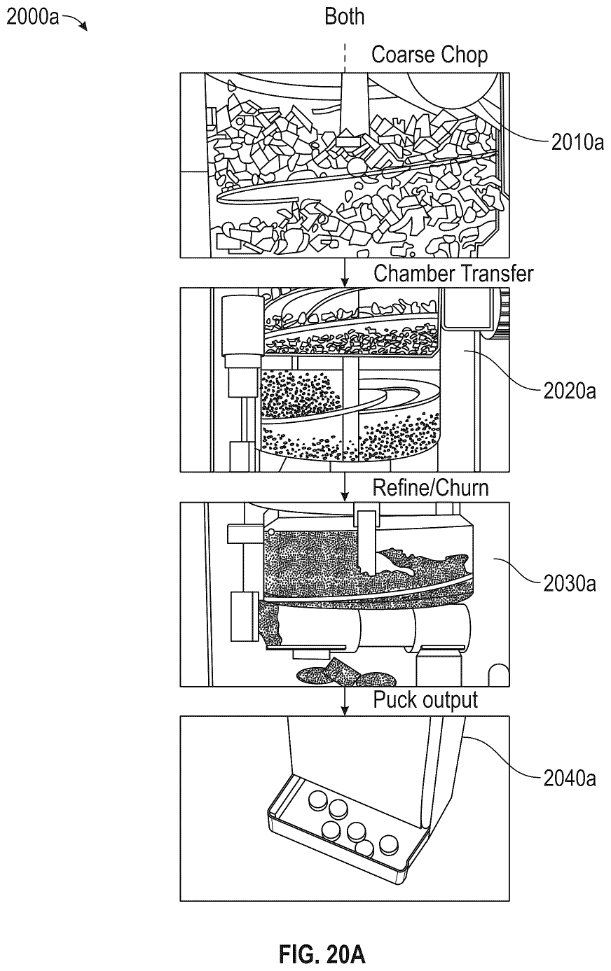

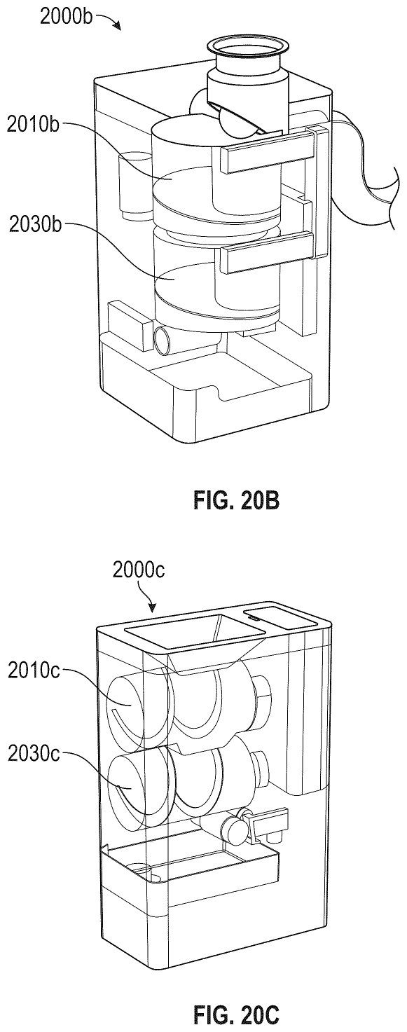

Referring now to FIGS. 20A-20C, a processing method 2000a and exemplary devices 2000b/2000c are shown, according to some implementations. Such a method 2000a and device 2000b/2000c may be described by any of the composting devices previously described with reference to FIGS. 13-16, or combination thereof. Further, the method 2000a and devices 2000b/2000c may be used after solids have been separated from fluids using any of the process described with reference to FIGS. 1-12, or may be used as a separate processing unit for use with solids that do not require being separated from a fluid.

The processing method 2000a may comprise chopping 2010a the solids, which may be accomplished, for example, in a chopping chamber 2010b/2010c. Chopping 2010a may be achieved, for example, by rotating paddles, flutes, or threads. The processing method further may comprise transferring 2020a the solids to a refining chamber 2030b/2030c. The method may further comprise refining 2030a the solids by churning or further grinding the solids in the refining chamber 2030b/2030c. The method may further comprise the step of extruding 2040a the processed solids out an extrusion opening 2030. Such extrusion may be achieved, for example, by a mechanical ram that forces the processed solids through the extrusion opening, thereby compacting the solids in the process. In an exemplar implementation, extruding 2040a may comprise extruding a puck-like shape of processed solids. Extruding 2040a may additionally comprise adding heat and/or moisture to the processed solids to allow the extruded solids to better retain a shape.

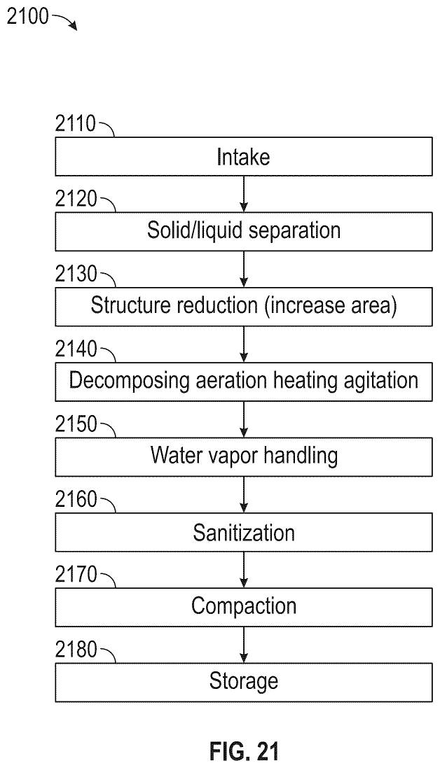

Further, any of the previously described heating and venting systems may be applicable in the method 2000a and devices 2000b/2000c. Further still, extruding the processed solids in a puck-like shape may be implemented in any of the previously described devices, systems, or methods. Referring now to FIG. 21, a process map 2100 is shown to generally illustrate a process utilized by the above-described solid separation and composting devices. During intake 2110, a mixture of solids and fluids may be disposed down the sink drain and enter the solid separation and composting device. As previously described, in some implementations, the mixture of fluids and solids directly enters the device, while in others the mixture may be first processed by a garbage disposal. Next, solid/fluid separation 2120 may occur, which may be achieved, for example, by any of the solids separation systems described with reference to FIGS. 1-12 or manually. Next, structure reduction 2130 may occur, which may be achieved, for example in any of the processing tunnels, chutes, or other components described with reference to FIGS. 13-16. Additionally, decomposing 2140 may occur, by aerating, heating, or agitating the solids. This step may also be achieved through any of the described processing tunnels or chutes and may utilize rotary drums, flutes, helical threads, or paddles. Further, the heat may be supplied through any of the methods previously described. The process may also include gas venting 2150, which may be achieved, for example, as described with reference to FIG. 18. The gases may include humid air produced by the drying solids as well as gases created as organic material decomposes. The process may also include sanitization 2160, which may be achieved, for example, through heat. Further, the process may include compaction 2170. As previously described, compaction 2170 can utilize a mechanical ram to compact or extrude the solids through an extrusion outlet and may add heat and/or moisture to better retain shape of the extruded solids. In some implementations, compaction 2170 may also be utilized to remove moisture from the solids. Further, the process includes storage 2180, which may include, for example, depositing the solids into a collection zone.

It is to be appreciated that multiple steps of the process may be accomplished at one instance in time. For example, the process may concurrently operate all described steps at the same time, if, for example, the process is continually operating while continued intake 2110 is occurring. Additionally, a particular solid in the system may undergo multiple steps at the same time. For example, a particular solid may concurrently undergo structure reduction 2130, decomposition 2140, gas venting 2150, sanitization 2160 and compaction 2170.

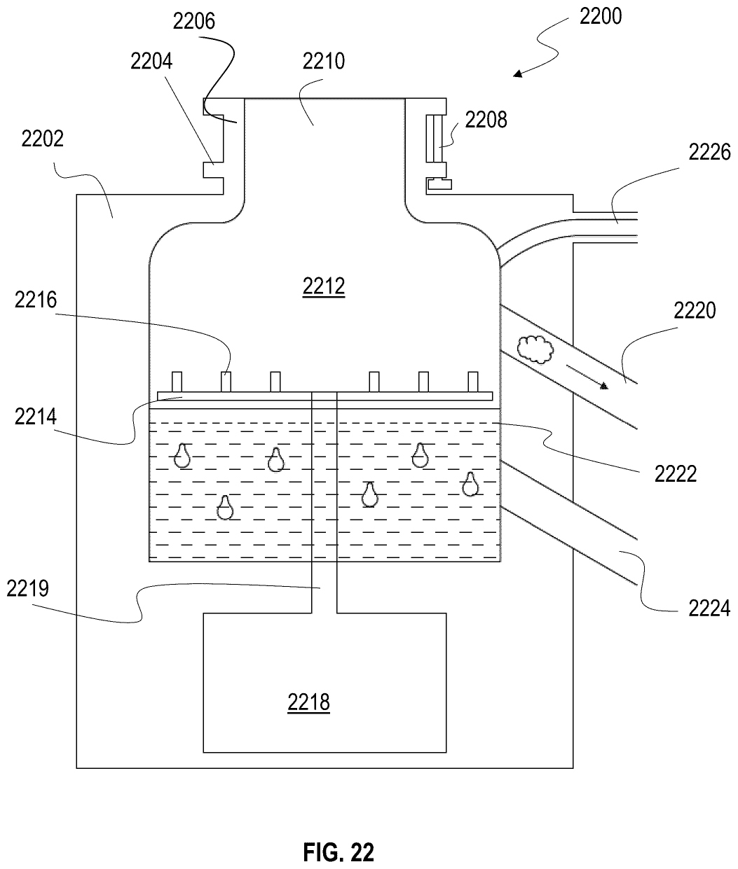

Referring now to FIG. 22, an under-sink garbage disposal and compost processing system 2200 is shown according to an exemplary implementation. System 2200 is configured to address a common issue of the loss of otherwise compostable food scraps or waste through the plumbing system. Typically when users System 2200 may include a garbage disposal 2202 mountable to a drain of a sink (not shown) by threading 2204 formed on an external neck 2206 of the garbage disposal 2202, by mechanical fasteners 2208 such as bolts, or both. Other connection means, such as flanges and bayonets, may also be contemplated. Neck 2206 may define an opening 2210 to an internal chamber 2212 of the garbage disposal 2202. The internal chamber 2212 may include a grinding mechanism, such as a grind plate 2214 with cogs 2216 extending upwardly from the grind plate 2214. Other grinding or chopping mechanisms may also be contemplated. The grinding mechanism may include a motor 2218 coupled to the grind plate 2214 via a rotable shaft 2219 fixed to the grind plate 2214 that allows the grind plate 2214 to rotate upon actuation of the motor 2218. The motor 2218 may be actuated by a user via remote or automatic means, or by manual actuation such as by a button or switch. In other examples, when foodstuff is detected in the chamber 2212, a sensor may signal to the motor 2218 to automatically run.

A compost outlet 2220 may positioned above the grind plate 2214 and in fluid communication with the chamber 2212. A compost collection container (not shown) or other collection mechanism may be coupled to an end of the compost outlet 2220 opposite the end coupled to the chamber 2212. The compost collection container may be removably attached, or may be a holding area for further processing of the compost as described in other examples.

The chamber 2212 may also include a screen 2222, such as a perforated screen as described with respect to the other examples, the grind plate 2214 may be perforated itself, or both. This may allow for water or other fluid introduced into the chamber 2212 to pass through to a water outlet 2224 to the central plumbing system or main drain, or to be recycled within the system. Water or other fluid may be introduced through the opening 2210 from the sink, by direction inject from a dishwater inlet 2226 (e.g., greywater), another fluid source such as an ozonated fluid source (not shown), or any combination.

In use, upon actuation of the motor 2218, the grind plate 2214 may rotate to grind foodstuff introduced from the sink through opening 2210 into smaller particles or pieces. Due to rotation of the spinning or rotating plate 2214, the ground foodstuff may be directed to the compost outlet 2220 via centrifugal force or inertia for collection in the compost collection container for further processing, while water or other fluid may be directed through the screen 2222 and into the water outlet 2224 for disposal or recycle. The compost collection container may then be removed and emptied into a compost bin or otherwise processed.

This example may prove to solve many problems associated with composting in the modern kitchen. Typically, users manually place food scraps into a compost bin without grinding them in the garbage disposal. This example reduces the problem of soggy food scraps in the compost bin and may allow the efficient separation of water or fluid from the garbage disposal waste. Further, this may allow for faster and more efficient compositing because whole food scraps decompose much more slowly than ground-up material. Further, food scraps are typically washed down the drain where they either enter a garbage disposal or enter the municipal plumbing system directly, which not only contributes to potential clogs and strains on the municipal plumbing system and city infrastructure, but also requires downstream separation of organic material from wastewater, resulting in an inefficient and resource-intensive process.

System 2200 (as well as other systems and devices disclosed herein) may provide a convenient way to collect finely ground compostable material which accelerates decomposition and improves the quality of home and business compost, it may reduce the volume of organic waste entering the plumbing system, easing the burden on wastewater treatment facilities and lowering maintenance costs, and by intercepting food waste after it passes through the garbage disposal and diverting it into a compost collection container, it may promote sustainability, efficiency, and responsible waste management at both the household and municipal levels.

The disclosure may be embodied in other specific forms without departing from the essential attributes. Therefore, the illustrated examples should be considered illustrative and not restrictive in all respects. Any claims provided herein are to ensure adequacy of the present application for establishing foreign priority and for no other purpose.

Various examples of systems, devices, and methods have been described herein. These examples are given only be way of example and are not intended to limit the scope of the claimed disclosures. It should be appreciated, moreover, that the various features of the examples that have been described may be combined in various ways to produce numerous additional examples. Moreover, while various material, dimensions, shapes, configurations, locations, etc. have been described for use with disclosed examples, others besides those disclosed may be utilized without exceeding the scope of the claimed disclosures.

Persons of ordinary skill in the relevant arts will recognize that the subject matter hereof may comprise fewer features than illustrated in any individual example described above. The examples described herein are not meant to be an exhaustive presentation of the ways in which the various features of the subject matter hereof may be combined. Accordingly, the examples are not mutually exclusive combinations of features; rather, the various examples may comprise a combination of different individual features selected from different individual examples, as understood be persons of ordinary skill in the art. Moreover, elements described with respect to one example may be implemented in other examples even when not described in such examples unless otherwise noted.

Any incorporation of reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed:

1. An under-sink solids separating device comprising:
a solids separation housing having structure defining a top opening at a top end of the housing, structure defining a fluid opening at a bottom end of the housing, and structure defining a solids opening positioned along a length of the housing between the top and bottom ends, and spaced a lateral distance from the top opening,
wherein the under-sink solids separating device is configured to separate fluid from solids when introduced within the top opening such that fluid exits the housing via the fluid opening and solids exit the housing via the solids opening.

2. The device of claim 1, wherein the top opening is configured to be coupled to a drain of a sink or a discharge end of a garbage disposal.

3. The device of claim 1, further comprising a composting housing coupled to the solids opening.

4. The device of claim 1, further comprising a screen positioned within the housing along a length of the housing and at an angle such that the screen covers the fluid opening while being configured to direct solids to the solids opening.

5. The device of claim 1, further comprising a curved separation surface positioned along a length of the housing and at an angle such that the curved separation surface covers at least a portion of the fluid opening, wherein the curved surface is shaped to create a pressure differential causing fluid to move along the curved surface to the fluid opening, while the solids continue to the solids opening.

6. The device of claim 1, further comprising:
a conveyor separation assembly positioned within the housing over the fluid opening, the conveyor separation assembly being configured to convey solids to the solids opening while fluid passes through the conveyor separation assembly to the fluid opening.

7. The device of claim 6, wherein the conveyor separation assembly comprises a substantially planar conveyance screen coupled to a least one roller configured to rotate to move the screen in a direction toward the solids opening.

8. The device of claim 6, wherein the conveyor separation assembly comprises a mesh conveyance wheel mounted on a central hug, the wheel being configured to rotate in a direction toward the solids opening.

9. The device of claim 1, further comprising:
a screen covering the fluid portion and at least a portion of the solids opening; and
a mechanical rack having at least one pusher member coupled thereto, the mechanical rack being positioned over the fluid opening and being configured to move the pusher member toward the solids opening to push solids on the screen into the solids opening while allowing fluid to pass therethrough.

10. The device of claim 1, further comprising:
a pair of separation rollers positioned above the fluid opening and adjacent to each other, wherein the separation rollers are configured to rotate in the same direction to convey solids from the top opening to the solids opening while allowing fluid to pass therethrough.

11. The device of claim 1, further comprising:
a rotatable screw having structure defining a helical thread, the rotatable screw being positioned within the housing such that an end of the screw is adjacent the solids opening, wherein the screw is configured to rotate to convey solids positioned thereon towards the solids opening.

12. A drain dumper solids separation system comprising:
a collection cup positionable below a drain of a sink or an outlet of a garbage disposal and having structure defining an open end; and
a cup shell having structure defining a plurality of openings defining a draining section, wherein the collection cup is positioned on a pivot point within the cup shell,
wherein the collection cup is pivotable through a first position in which the open end is aligned with the drain for collection of solids and fluids, a second position in which the open end faces the straining section of the cup shell and the fluid flows through the straining section while the solids remain within the collection cup, and a third position in which the open end faces in a direction in which gravity causes the solids to move out of the collection cup.

13. The system of claim 12, further comprising:
a strainer positioned above the collection cup, the stainer including structure defining a plurality of openings for allowing fluid to pass therethrough when the collection cup is in each of the second and third positions.

14. The system of claim 12, wherein the collection cup is pivotable through at least two of the first, second, and third positions via mechanical activation.

15. The system of claim 12, wherein the collection cup is pivotable through at least two of the first, second, and third positions via a motor operably coupled to the pivot point to rotate the collection cup.

16. The system of claim 12, further comprising a composting system coupled to the cup shell, the compositing system comprising:
a processing tunnel configured to convey solids therealong;
a grinding or cutting mechanism for grinding or cutting the solids;
a heating element for removing moisture from the solids; and
a collection zone configured to collect the processed solids,
wherein when the collection cup is in the third position, the open end faces the processing tunnel.

17. The device of claim 12, further comprising a composting system coupled to the solids opening, the compositing system comprising:
a processing tunnel configured to convey solids therealong;
a grinding or cutting mechanism for grinding or cutting the solids;
a heating element for removing moisture from the solids; and
a collection zone configured to collect the processed solids.

18. An under-sink solid composting device comprising:
a grind or chop chamber;
a processing chamber in communication with the grind chamber;
a perforated divider positioned between the grind or chop chamber and the processing chamber; and
a rotatable central shaft having a first set of paddle arms extending radially outwardly into the grind or chop chamber,
wherein the first set of paddle arms are configured to grind or chop solid material therebetween until the solid material is ground to a size small enough to pass through the perforated divider to the processing chamber, and
wherein the processing chamber includes at least one of a heater, a drier, and a compacting device configured to process the solid material into pucks.

19. The device of claim 18, further comprising:
a removable collection chamber for receiving the pucks therein.

20. The device of claim 18, wherein the rotatable central shaft includes a second set of paddle arms extending radially outwardly into the processing chamber, the second set being configured to further grind or chop the solid material.
